(19) United States
(12) Patent Application Publication
(10) Pub. No.: US 2026/0318446 A1
(43) Pub. Date: Oct. 15, 2026

(54) MULTI-CONFIGURATION, MODULAR SUPPORT APPARATUS AND SYSTEM

(71) Applicant: Gary Hoogervorst, Cape Coral, FL (US)

(72) Inventor: Gary Hoogervorst, Cape Coral, FL (US)

(21) Appl. No.: 19/174,074

(22) Filed: Apr. 9, 2025

(51) Int. Cl. F16L 3/22; F16M 11/24

(52) U.S. Cl. CPC F16L 3/22; F16M 11/24

(57) ABSTRACT

A multi-configuration, modular support apparatuses and systems for mechanical infrastructure includes interchangeable components configured for tool-less or low-tool assembly. Components may be pressure-fit, clamped, or otherwise coupled to permit adjustable, reusable configurations without welding. The system supports vertical and lateral loads and may include field-adaptable features for varied installation environments.

### FIELD

The present invention relates to modular support apparatuses and systems, and more specifically, to a multi-configuration modular apparatus and system designed to support industrial piping and similar overhead installations.

### BACKGROUND

### Challenges With Support Systems

Supporting industrial piping and other structural loads has become increasingly challenging due to the lack of a standardized, adaptable stand system. Existing supports typically require custom fabrication on-site, necessitating extensive material preparation, including cutting, drilling, and welding to meet project-specific requirements. This approach is time-consuming, labor-intensive, and reliant on skilled workers, leading to increased costs and delays.

Additionally, logistical inefficiencies pose significant obstacles. Raw materials must be transported separately, increasing shipping costs and material waste. Construction variability can also result in inconsistencies in fabrication, making it difficult to achieve uniformity across multiple installations. The need for site-specific modifications further complicates assembly, as unexpected adjustments often lead to errors, costly rework, and extended project timelines.

### Financial and Logistical Burdens

The financial burden associated with these inefficiencies is substantial. Industrial piping projects can cost between $1 million and $50 million, with shipping expenses alone accounting for 15% to 25% of total project costs. This translates to transportation costs ranging from $150,000 to $12.5 million per project, significantly impacting overall budgets. Moreover, additional expenses arise from on-site labor, fabrication, and project delays, all of which contribute to budget overruns and increased operational expenses.

The reliance on custom fabrication also results in wasted material and inefficient labor allocation, as excess raw materials must be accounted for in case of errors or adjustments. These factors make the current industry approach unsustainable, particularly for large-scale installations requiring repeatable, standardized configurations.

### Workplace Safety Risks

Beyond financial concerns, worker safety is a critical issue in industrial piping installation. The construction industry accounts for a disproportionate share of occupational fatalities, accounting for approximately one in five workplace deaths as of 2023. Industrial piping installations, in particular, present heightened risks, as workers frequently engage in elevated work, heavy lifting, and welding operations in unpredictable environments.

The requirement for on-site welding, manual fabrication, and excessive handling increases the likelihood of injuries related to falls, burns, repetitive strain, and exposure to hazardous materials. Minimizing the need for elevated work, on-site modifications, and hazardous assembly processes is an ongoing concern for regulatory agencies and industry professionals seeking to improve workplace safety.

### Impact of Increasing Natural Disasters on Industrial Infrastructure

In recent years, the frequency and severity of natural disasters—including hurricanes, earthquakes, and extreme weather events—have increased, placing greater demands on industrial infrastructure. Industrial piping installations, structural supports, and load-bearing systems are particularly vulnerable to high winds, seismic activity, and environmental degradation, requiring reinforced, code-compliant solutions to ensure long-term reliability.

Regulatory agencies and industry standards have adapted to these challenges by implementing stricter guidelines for structural safety and disaster resilience. Compliance with hurricane codes, seismic requirements, and load-bearing regulations has become increasingly complex and expensive, particularly for traditional custom-fabricated support systems. Many existing solutions lack the flexibility to be efficiently adapted to evolving codes or site-specific environmental factors, further complicating installation and increasing costs.

As a result, there is a growing need for an adaptable, cost-effective, and regulatory-compliant support system that can withstand harsh environmental conditions while reducing installation challenges, financial burdens, and workplace safety risks. A pre-engineered, modular solution capable of integrating reinforced anchoring, load distribution mechanisms, and material treatments for corrosion and impact resistance would address these concerns while maintaining compliance with evolving industry standards.

### The Need for a Versatile, Cost-Effective, and Safer Support System

Given the financial, logistical, and safety challenges in industrial piping support systems and support systems in general, there has been a long-standing, hard-felt need for a more efficient, adaptable, safer, and cost-effective solution. A system that could reduce or eliminate the need for custom fabrication on-site, minimize shipping and installation costs, and enhance worker safety without compromising the effectiveness of the support would address multiple long-standing industry pain points.

It would be beneficial to have a modular, pre-engineered support system capable of adapting to various load requirements, regulatory standards, and environmental conditions. Such a solution would provide a cost-effective, safer, and scalable alternative to traditional fabrication methods, reducing project timelines, labor costs, and safety risks while maintaining structural integrity and reliability.

### SUMMARY

An object of the present invention is to provide modular support structures, specifically a multi-configuration modular stand designed to support industrial piping and similar overhead installations.

In embodiments, a multi-configuration, modular stand comprises a first configuration comprising: a baseplate configured to be coupled to a surface, the baseplate comprising: a first horizontal section comprising a plurality of apertures operable to receive one or more bolts to mechanically couple the baseplate to the surface, wherein a first side of the first horizontal section is adjacent to the surface, and wherein the first horizontal section is substantially parallel to the surface; and a first vertical section, wherein the first vertical section is a first tubular element, wherein the first vertical section is adjacent to a second side of the first horizontal section, wherein the first vertical section is coupled to the first horizontal section, and wherein the first vertical section has a first radius; wherein the baseplate is made of extruded aluminum; a vertical column, tubular in shape, the vertical column having a second radius sized to be received within the first vertical section, and wherein the vertical column is made of extruded aluminum; and a top connector comprising: a second horizontal section having a first thickness, the second horizontal section comprising a first side of the second horizontal section and a second side of the second horizontal section, wherein the second horizontal section is substantially parallel to the first horizontal section; and a second vertical section, wherein the second vertical section is a second tubular element, wherein the second vertical section is adjacent to the first side of the second horizontal section, wherein the second vertical section has a third radius sized configured to receive to receive the vertical column, wherein the third radius is substantially similar to the first radius, and wherein the second vertical section is made of extruded aluminum; and a top support comprising: a third vertical section having a first end of the third vertical section and a second end of the third vertical section; a third horizontal section having a first end of the third horizontal section and a second end of the second horizontal section; and a fourth vertical section having a first end of the fourth vertical section and a second end of the fourth vertical section, wherein the first end of the third vertical section is coupled to the first end of the third horizontal section and the second end of the second horizontal section is coupled to the first end of the fourth vertical section such that the third vertical section, third horizontal section, and fourth vertical section form a u-shape, wherein the top support is made of extruded aluminum, and wherein the top support comprises a plurality of channels, the plurality of channels comprising: a first extruded channel having a first width configured to receive a first end of the second horizontal section having the first thickness, the first extruded channel being formed by a first portion of the third horizontal section, a first portion of the third vertical section, and a first channel section extending perpendicularly from the third vertical section and substantially parallel to the third horizontal section; and a second extruded channel having a second width configured to receive a second end of the second horizontal section having the first thickness, wherein the second width is substantially similar to the first width, the second extruded channel being formed by a second portion of the third horizontal section, a first portion of the fourth vertical section, and a second channel section extending perpendicularly from the fourth vertical section and substantially parallel to the third horizontal section; and a second configuration configured to support industrial piping, the second configuration comprising: the first configuration assembled into a single stand, such that: the first vertical section is coupled to a first end of the vertical column via pressure fitting the first end of the vertical column inside the first vertical section; the second vertical section is coupled to a second end of the vertical column via pressure fitting the second end of the vertical column inside the second vertical section; and the top support is coupled to the second horizontal section via pressure fitting a first end of the second horizontal section inside the first extruded channel and pressure fitting a second end of the second horizontal section inside the second extruded channel, wherein the single stand is configured to support one-thousand pounds, and wherein the single stand is configured to weigh less than one-hundred pounds.

In embodiments, the first tubular element and the second tubular element are Schedule 40 or an equivalent structural pipe standard.

In embodiments, the vertical column is Schedule 40 or an equivalent structural pipe standard.

In embodiments, the first tubular element and the second tubular element are Schedule 80 or an equivalent structural pipe standard.

In embodiments, the vertical column is Schedule 80 or an equivalent structural pipe standard.

In embodiments, each of the one or more bolts comprises one or more washers made of nylon.

In embodiments, when the first end of the second horizontal section is fully inserted in the first extruded channel, the first extruded channel comprises: a first gap between a first proximal end of the second horizontal section and a second proximal end of the first extruded channel, wherein the first gap receives a first lock block configured to secure the first end of the second horizontal section; and a second gap between a first distal end of the second horizontal section and a second distal point of the first extruded channel, wherein the second gap receives a second lock block configured to secure the first end of the second horizontal section; and when the second end of the second horizontal section is fully inserted in the second extruded channel, the second extruded channel comprises: a third gap between a third proximal end of the second horizontal section and a fourth proximal end of the second extruded channel, wherein the third gap receives a third lock block configured to secure the second end of the second horizontal section; and a fourth gap between a third distal end of the second horizontal section a fourth distal end of the second extruded channel wherein the fourth gap receives a fourth lock block configured to secure the second end of the second horizontal section.

In embodiments, a first intersection between the first portion of the first portion of the third horizontal section and the first portion of the third vertical section within the first extruded channel is formed at an angle greater than 90 degrees; and a second intersection between the second portion of the first portion of the third horizontal section and the first portion of the fourth vertical section within the second extruded channel is formed at an angle greater than 90 degrees

In embodiments, the multi-configuration, modular stand further comprises: a second multi-configuration, modular stand configured to be connected to the multi-configuration, modular stand, the second multi-configuration, modular stand, comprising: a second baseplate configured to be coupled to the surface, the baseplate comprising: a fourth horizontal section, the fourth horizontal section being substantially parallel to the first horizontal section; and a fifth vertical section, wherein the fifth vertical section is a third tubular element, wherein the fifth vertical section is adjacent to the fourth horizontal section, wherein the fifth vertical section is perpendicular to the fourth horizontal section, wherein the fifth vertical section is coupled to the fourth horizontal section, and wherein the fifth vertical section has a fourth radius; wherein the second baseplate is made of extruded aluminum; a second vertical column, tubular in shape, the second vertical column having a fifth radius sized to be received within the fifth vertical section, and wherein the second vertical column is made of extruded aluminum; and a second top connector comprising: a fifth horizontal section having a second thickness, the fifth horizontal section comprising a first side of the fifth horizontal section and a second side of the fifth horizontal section, wherein the fifth horizontal section is substantially parallel to the fourth horizontal section; and a sixth vertical section, wherein the sixth vertical section is a fourth tubular element, wherein the sixth vertical section is adjacent to the fifth horizontal section, wherein the sixth vertical section is perpendicular to the fifth horizontal section, wherein the second vertical section has a sixth radius sized configured to receive to receive the second vertical column, wherein the sixth radius is substantially similar to the fourth radius, and wherein the second vertical section is made of extruded aluminum; and a second top support comprising: a seventh vertical section having a first end of the seventh vertical section and a second end of the seventh vertical section; a sixth horizontal section having a first end of the sixth horizontal section and a second end of the sixth horizontal section; and an eighth vertical section having a first end of the eighth vertical section and a second end of the eighth vertical section, wherein the first end of the seventh vertical section is coupled to the first end of the sixth horizontal section and the second end of the sixth horizontal section is coupled to the first end of the eighth vertical section such that the seventh vertical section, sixth horizontal section, and eighth vertical section form a second u-shape, wherein the second top support is made of extruded aluminum, and wherein the second top support comprises a second plurality of channels, the second plurality of channels comprising: a third extruded channel having a third width configured to receive a first end of the fifth horizontal section having the second thickness; and a fourth extruded channel having a fourth width configured to receive a second end of the fifth horizontal section having the second thickness, wherein the fourth width is substantially similar to the third width, wherein the second multi-configuration, modular stand is assembled such that: the fifth vertical section is coupled to a first end of the second vertical column via pressure fitting the first end of the second vertical column inside the fifth vertical section; the sixth vertical section is coupled to a second end of the second vertical column via pressure fitting the second end of the second vertical column inside the sixth vertical section; and the second top support is coupled to the second horizontal section via pressure fitting a first end of the fifth horizontal section inside the third extruded channel and pressure fitting a second end of the fifth horizontal section inside the fourth extruded channel.

In embodiments, the vertical column further comprises a first coupling element; the second vertical further column comprises a second coupling element; and the first coupling element is mechanically coupled to the second coupling element via a first cross-member support.

In embodiments, the first coupling element and the second coupling element are on different planes.

In embodiments, the vertical column further comprises a third coupling element; the second vertical column further comprises a fourth coupling element; and the third coupling element is mechanically coupled to the fourth coupling element via a second cross-member support.

In embodiments, the third coupling element and the fourth coupling element are on different planes.

In embodiments, the first coupling element and the third coupling element are substantially in a first plane, and wherein the second coupling element and the fourth coupling element are on a second plane.

In embodiments, the multi-configuration modular stand is configured to support two-thousand pounds.

In embodiments, a multi-configuration, modular stand comprises: a first configuration comprising: a baseplate configured to be coupled to a surface, the baseplate comprising: a first horizontal section comprising a plurality of apertures operable to receive one or more bolts to mechanically couple the baseplate to the surface, wherein a first side of the first horizontal section is adjacent to the surface, and wherein the first horizontal section is substantially parallel to the surface; and a first vertical section, wherein the first vertical section is a first tubular element, wherein the first vertical section is adjacent to a second side of the first horizontal section, wherein the first vertical section is coupled to the first horizontal section, and wherein the first vertical section has a first radius; wherein the baseplate is made of extruded aluminum; a vertical column, tubular in shape, the vertical column having a second radius sized to be received within the first vertical section, and wherein the vertical column is made of extruded aluminum; and a top connector comprising: a second horizontal section, wherein the second horizontal section is substantially parallel to the first horizontal section, wherein the second horizontal section has a first width, and wherein the second horizontal section has a first length; and a second vertical section, wherein the second vertical section is a second tubular element, wherein the second vertical section is adjacent to the first side of the second horizontal section, wherein the second vertical section having a third radius sized configured to receive to receive the vertical column, wherein the third radius is substantially similar to the first radius, and wherein the second vertical section is made of extruded aluminum; and a top support comprising: an I-beam having a second length and a second width, wherein the second length is greater than the first length, wherein the second width is configured to enable the I-beam to be mechanically coupled to the second horizontal section via a plurality of coupling mechanisms, wherein the plurality of coupling mechanisms comprise four collars configured to mechanically couple the I-beam and the second horizontal section; and a second configuration configured to support industrial piping, the second configuration comprising: the first configuration assembled into a single stand, such that: the first vertical section is coupled to a first end of the vertical column via pressure fitting the first end of the vertical column inside the first vertical section; the second vertical section is coupled to a second end of the vertical column via pressure fitting the second end of the vertical column inside the second vertical section; and the I-beam is coupled to the second horizontal section via the plurality of coupling mechanisms, wherein the single stand is configured to support two-thousand pounds.

In embodiments, the multi-configuration, modular stand further comprises: a second multi-configuration, modular stand configured to be connected to the multi-configuration, modular stand, the second multi-configuration, modular stand, comprising: a second baseplate configured to be coupled to the surface, the baseplate comprising: a fourth horizontal section, the fourth horizontal section being substantially parallel to the first horizontal section; and a fifth vertical section, wherein the fifth vertical section is a third tubular element, wherein the fifth vertical section is adjacent to the fourth horizontal section, wherein the fifth vertical section is perpendicular to the fourth horizontal section, wherein the fifth vertical section is coupled to the fourth horizontal section, and wherein the fifth vertical section has a fourth radius; wherein the second baseplate is made of extruded aluminum; a second vertical column, tubular in shape, the second vertical column having a fifth radius sized to be received within the fifth vertical section, and wherein the second vertical column is made of extruded aluminum; and a second top connector comprising: a fifth horizontal section having a second thickness, the fifth horizontal section comprising a first side of the fifth horizontal section and a second side of the fifth horizontal section, wherein the fifth horizontal section is substantially parallel to the fourth horizontal section; and a sixth vertical section, wherein the sixth vertical section is a fourth tubular element, wherein the sixth vertical section is adjacent to the fifth horizontal section, wherein the sixth vertical section is perpendicular to the fifth horizontal section, wherein the second vertical section has a sixth radius sized configured to receive to receive the second vertical column, wherein the sixth radius is substantially similar to the fourth radius, and wherein the second vertical section is made of extruded aluminum; and a second top support comprising: a second I-beam having a fourth length and a fourth width, wherein the fourth length is greater than the third length, wherein the fourth width is configured to enable the second I-beam to be mechanically coupled to the fourth horizontal section via a second plurality of coupling mechanisms, wherein the second plurality of coupling mechanisms comprise at least four collars configured to mechanically couple the second I-beam and the fourth horizontal section; and wherein the second multiconfiguration, modular stand is assembled, such that: the third vertical section is coupled to a first end of the second vertical column via pressure fitting the first end of the second vertical column inside the third vertical section; the fourth vertical section is coupled to a second end of the second vertical column via pressure fitting the second end of the second vertical column inside the fourth vertical section; and the second I-beam is coupled to the fourth horizontal section via the second plurality of coupling mechanisms.

In embodiments, the vertical column further comprises a first coupling element; the second vertical further column comprises a second coupling element; and the first coupling element is mechanically coupled to the second coupling element via a first cross-member support.

In embodiments, the vertical column further comprises a third coupling element; the second vertical column further comprises a fourth coupling element; and the third coupling element is mechanically coupled to the fourth coupling element via a second cross-member support.

In embodiments, the first coupling element and the third coupling element are substantially in a first plane, wherein the second coupling element and the fourth coupling element are on a second plane, wherein the first plane is different from the second plane.

This and other objects shall be addressed by embodiments of the present invention as set forth herein.

### BRIEF DESCRIPTION OF THE DRAWINGS

Exemplary embodiments of the present invention will be described with references to the accompanying figures, wherein:

FIG. 1A is a front view of a multiconfiguration, modular apparatus, in accordance with various embodiments of the present invention;

FIG. 1B is a side view of a multiconfiguration, modular apparatus, in accordance with various embodiments of the present invention;

FIG. 1C is a perspective view of a multiconfiguration, modular apparatus, in accordance with various embodiments of the present invention;

FIG. 2 is a perspective view of a plurality of multi-configuration, modular apparatuses, each corresponding to the multi-configuration, modular apparatus represented in FIGS. 1A, 1B, and 1C, supporting a plurality of industrial pipes, in accordance with various embodiments of the present invention;

FIG. 3A is a front view of a plurality of multi-configuration, modular apparatuses, each corresponding to the multi-configuration, modular apparatus represented in FIGS. 1A, 1B, and 1C, supporting a plurality of industrial pipes, in accordance with various embodiments of the present invention;

FIG. 3B is a side view of a plurality of multi-configuration, modular apparatuses, each corresponding to the multi-configuration, modular apparatus represented in FIGS. 1A, 1B, and 1C, supporting a plurality of industrial pipes, in accordance with various embodiments of the present invention;

FIG. 3C is an enlarged view of a first portion of the plurality of multi-configuration, modular apparatuses depicted in FIG. 3A, and 3B, in accordance with various embodiments of the present invention;

FIG. 3D is an enlarged view of a second portion of the plurality of multi-configuration, modular apparatuses depicted in FIG. 3A, and 3B, in accordance with various embodiments of the present invention;

FIG. 4A is an enlarged view of a base plate of a multi-configuration, modular apparatus, in accordance with various embodiments of the present invention;

FIG. 4B is an enlarged view of a vertical column, top connector, and top support of a multi-configuration, modular apparatus, in accordance with various embodiments of the present invention;

FIG. 4C is a cross-sectional view taken along line A-A of FIG. 4B, illustrating exemplary internal structural details of a multi-configuration, modular apparatus, in accordance with various embodiments of the present invention;

FIG. 5 is a top support of a multi-configuration, modular apparatus, including a lock-block, in accordance with various embodiments of the present invention;

FIG. 6 is an enlarged view of a top support of a multi-configuration, modular apparatus, in accordance with various embodiments of the present invention;

FIG. 7 is an enlarged view of a portion of a top support of a multi-configuration, modular apparatus, illustrating its attachment to an external support structure via a fastening mechanism, in accordance with various embodiments of the present invention;

FIG. 8A is an exploded view of a multi-configuration, modular apparatus, illustrating an exemplary arrangement and assembly of its components, in accordance with various embodiments of the present invention;

FIG. 8B is a side view of the multi-configuration, modular apparatus represented in FIG. 8A, in accordance with various embodiments of the present invention;

FIG. 8C is an enlarged view of an adapter for a top connector of a multi-configuration, modular apparatus, in accordance with various embodiments of the present invention;

FIG. 8D is an enlarged view of a portion of a multi-configuration, modular apparatus and adapter shown depicted in FIG. 8C, in accordance with various embodiments of the present invention;

FIG. 9A is a side view of a lock-block, in accordance with various embodiments of the present invention;

FIG. 9B is a perspective view of the lock-block of FIG. 9A, illustrating features hidden from view using hidden lines, in accordance with various embodiments of the present invention;

FIG. 10A is a perspective view of a support of a multi-configuration, modular apparatus, in accordance with various embodiments of the present invention;

FIG. 10B is a top view of a support of a multi-configuration, modular apparatus, in accordance with various embodiments of the present invention; and

FIG. 11 is an enlarged view of a baseplate, vertical column and fasteners of a multi-configuration, modular apparatus, in accordance with various embodiments of the present invention.

### DETAILED DESCRIPTION

The present invention relates to a multi-configuration, modular stand. As used herein, the term “multi-configuration apparatus” may be referred to interchangeably as “the stand,” “the modular stand,” “the multi-configuration stand,” “the apparatus,” or “the system.” These terms are intended to be used synonymously and should not be construed as limiting to any particular embodiment, configuration, or structural variation of the invention. In embodiments, the multi-configuration, modular stand includes interlocking components, extruded channels, and coupling mechanisms, enabling secure and adaptable installations. The stand itself is designed to accommodate various top support configurations, including I-beams and alternative structural members, such as extruded aluminum top supports, ensuring compatibility with different load-bearing requirements and installation conditions. The reinforced top support structures allow for secure mounting of industrial piping, conduit systems, and general loads. The one or more adjustable cross-member supports provide additional flexibility in size, load distribution, and positioning, ensuring that loads are distributed evenly to prevent localized stress points. The integration of extruded channels and coupling mechanisms enables precise alignment during installation, reducing the likelihood of misalignment-related failures. Additionally, the modular stand's pre-configured attachment points streamline the assembly process, allowing for quick and repeatable installations across multiple job sites.

In some embodiments, the design of the stand eliminates the need for on-site welding, relying instead on pressure fittings, bolted connections, or other mechanical fastening methods, further simplifying assembly and reducing installation time and labor costs. In some embodiments, the stand includes lock blocks, which may be made from nylon or other suitable materials to prevent erosion or damage to the extruded aluminum or other structural materials of the stand while still effectively securing components in place. The lock blocks, in embodiments, assist with small adjustments and fine-tuning during installation, ensuring proper alignment and stability. This feature, combined with the absence of welded connections in some embodiments, allows for greater flexibility and ease of assembly in diverse installation environments.

In embodiments, the stand's versatile assembly options enable adaptation to different mounting surfaces, attachment points, and load-bearing scenarios, facilitating compliance with regional and industry-specific building codes, including hurricane resistance standards, seismic requirements, and load-rating specifications. In embodiments, the stand includes additional supports and anchors, such as one or more cables engineered to withstand harsh environmental conditions, including high wind loads, seismic activity, and heavy mechanical loads. The incorporation of high-strength materials, corrosion-resistant coatings, and reinforced anchoring systems ensures that the apparatuses maintain structural integrity over prolonged operational use. The ability to adjust and reinforce the stand based on specific site conditions makes it particularly well-suited for demanding industrial environments, such as refineries, chemical plants, and infrastructure projects.

In embodiments, additional supports and anchors are provided to meet various regulatory requirements, such as building codes, hurricane codes, seismic codes, and other structural safety standards. The incorporation of adjustable configurations and multiple anchoring options ensures that the apparatuses can be installed efficiently in various environments, ranging from temporary field deployments to permanent infrastructure installations. The multi-configuration, modular stand enhances safety and cost-effectiveness by reducing fabricating and shipping costs, assembly time, installation risks, minimizing worker fatigue, and decreasing the likelihood of injury during handling and assembly. The design reduces the need for elevated work, excessive manual handling, on-site welding, and exposure to dangerous fabrication processes, enhancing overall worksite safety and compliance with OSHA and other industry safety standards.

In embodiments, the multi-configuration, modular stand is designed to maximize efficiency in shipping, installation, and long-term structural performance. The apparatuses are composed of lightweight, high-strength materials, reducing shipping costs and simplifying transportation logistics compared to traditional heavy-gauge steel support structures. The modular design further enhances packing efficiency, allowing multiple components to be stacked or nested for compact shipping and storage while minimizing waste. The apparatuses are designed for cost-effective shipping and logistics, utilizing modular packaging, stackable components, and lightweight materials to reduce freight expenses while maintaining durability. The ability to ship pre-engineered, ready-to-assemble components minimizes the need for excessive handling, cutting, and on-site modifications, thereby reducing labor costs, installation time, worker injury risk, and material waste.

In embodiments, the apparatuses are engineered for rapid on-site assembly, reducing the need for specialized tools or labor-intensive construction processes. The interlocking components, extruded channels, and coupling mechanisms allow for intuitive and secure assembly, minimizing installation time and associated labor costs. Additionally, the apparatuses are designed with integrated assistance features that facilitate the installation of industrial piping and other general loads, ensuring proper alignment, load distribution, and structural reinforcement while reducing strain on workers.

In embodiments, the apparatuses and systems provide adaptability, allowing for customization to different load requirements, improving durability, stability, and overall structural integrity of both the support framework and the industrial piping it accommodates. The combination of lightweight materials, ease of assembly, and robust load-bearing capacity results in a cost-effective, scalable solution for industrial, commercial, and infrastructure applications.

In embodiments, as used throughout this application, industrial piping refers to a general load that the multi-configuration modular apparatus can support, including but not limited to piping systems, conduit structures, and other load-bearing elements. The modular apparatus is designed to provide structural support, weight distribution, and stability for a variety of applications, which may include fluid transport systems, structural conduits, mechanical assemblies, or general load-bearing frameworks in industrial, commercial, and infrastructure settings.

In embodiments, industrial piping may refer to process piping, which transports fluids or chemicals within industrial facilities such as petrochemical plants, refineries, and food processing plants, or utility piping, which distributes water, air, and other essential utilities in industrial and commercial buildings. It may also include compressed air systems, which transport pressurized air for pneumatic tools, manufacturing processes, or HVAC applications, as well as steam distribution networks, which serve high-pressure steam transport in industrial and power generation settings.

Additional examples of industrial piping include chemical transfer lines, rated for corrosive, toxic, or high-temperature chemical transport, fire suppression piping, which consists of networks for sprinkler systems, foam-based fire suppression, and high-pressure water delivery, and HVAC ducting and piping, which support heating, ventilation, and air conditioning applications, including chilled water and refrigerant lines. Industrial piping may also refer to structural conduits, which are enclosed piping systems designed for routing cables, support structures, or load-bearing components within industrial frameworks.

In embodiments, the modular apparatus may also support general loads such as equipment platforms, cable trays, electrical enclosures, mechanical housings, and storage racks, to name a few. The apparatus'adaptability allows it to be used for temporary or permanent load-bearing configurations, distributing forces evenly while maintaining stability. Depending on the specific implementation, the apparatus can be configured to accommodate dynamic loads, vibration-sensitive equipment, and environmental constraints, to name a few.

In embodiments, as used throughout this application, the terms “Schedule 40” and “Schedule 80” piping refer to standardized classifications of pipe wall thickness as defined by the American National Standards Institute (ANSI) and the American Society of Mechanical Engineers (ASME). These classifications are used in industrial, commercial, and infrastructure applications to determine the pressure capacity, strength, and durability of a given pipe size and material composition.

In embodiments, Schedule 40 piping refers to a medium-wall thickness pipe commonly used for low-to moderate-pressure applications, including water distribution, drainage, and general industrial piping. Schedule 40 pipes typically provide sufficient structural integrity for standard load-bearing and fluid transport applications while maintaining cost-efficiency and ease of installation.

In embodiments, Schedule 80 piping refers to a thicker-walled pipe designed for high-pressure applications where increased strength and durability are required. Schedule 80 pipes feature greater resistance to mechanical stress, impact, and internal pressure loads, making them suitable for demanding environments, such as high-pressure chemical processing, steam transport, and structural piping in industrial facilities.

In embodiments, the multi-configuration, modular stand may be designed to support both Schedule 40 and Schedule 80 piping, ensuring compatibility across a wide range of load conditions and industrial requirements. The stand's versatile mounting configurations, coupling mechanisms, and material options allow for secure attachment and load distribution for different pipe schedules, enhancing stability and compliance with industry standards.

In embodiments, as used throughout this application, a coupling mechanism refers to any structural assembly, fastening system, or integrated connection interface designed to secure one component to another while accommodating load transfer, alignment tolerances, and environmental stresses. These mechanisms are designed to ensure structural stability, facilitate modularity, and allow for secure and adjustable connections in industrial, commercial, and infrastructure applications.

In embodiments, a coupling mechanism may refer to pressure fittings, which rely on radial compression or interference fit to maintain engagement without the need for threaded fasteners, or collars and clamps, which provide adjustable or rigid securing through bolted or hinged closures to guide, fix, or limit movement between structural components. It may also include threaded fasteners, such as bolted connections, which utilize high-strength bolts, washers, and locking nuts to create a removable yet rigid coupling, as well as flanged joints, which feature precision-machined mating surfaces secured with gaskets and bolted interfaces to ensure a fluid-tight or load-bearing engagement.

Additional examples of coupling mechanisms include pinned connections, which employ shear pins or dowel inserts to allow controlled rotational articulation or force distribution between joined components, and welded joints, which create permanent, high-strength connections through fusion welding, such as MIG, TIG, or arc welding techniques, ensuring structural continuity and load-bearing efficiency. In some embodiments, a coupling mechanism may also involve adhesive bonding, utilizing industrial-strength epoxies or structural adhesives to form high-load connections between dissimilar materials, or riveted joints, where metal fasteners create semi-permanent attachments with shear-resistant properties.

These mechanisms may be incorporated into the modular stand system to provide secure, reconfigurable, and load-rated connections between vertical supports, cross-members, and load-bearing interfaces, ensuring adaptability to thermal expansion, mechanical vibrations, and seismic loads, to name a few.

In embodiments, the multi-configuration, modular stand integrates multiple coupling mechanisms to provide secure, reconfigurable, and load-rated connections between vertical supports, cross-members, and load-bearing interfaces. These mechanisms may be designed to accommodate thermal expansion, mechanical vibrations, and seismic loads, ensuring long-term reliability in industrial settings.

In embodiments, as used throughout this application, an I-beam refers to a structural support member with a cross-sectional profile characterized by a central web extending perpendicularly between two flanges, forming an “I” shape. The web provides shear resistance, while the flanges offer high bending resistance, resulting in an optimal strength-to-weight ratio.

In embodiments, the I-beam may be fabricated from rolled steel, extruded aluminum, or composite materials, depending on the load requirements and environmental conditions. The beam's moment of inertia and section modulus are engineered to distribute loads efficiently while minimizing material usage. In comparison to other embodiments of the apparatus which include U-shaped supports, an I-beam may provide greater lateral stiffness reducing deflection and torsional instability.

In embodiments, the I-beam is secured to the top of the multi-configuration modular stand using industrial clips or collars. In some embodiments, the I-beam may be integrated into the structure through pre-drilled connection points, precision-cut apertures, or reinforced coupling interfaces. To enhance durability, in embodiments, additional coatings or surface treatments may be applied to the apparatus which may improve corrosion resistance or adapt the apparatus for specialized environments, such as high-temperature or chemically reactive industrial applications.

In embodiments, as used throughout this application, the term “hurricane code” refers to building, structural, and engineering standards established to enhance the resilience of structures against high winds, uplift forces, and extreme weather events. In embodiments, hurricane codes define structural reinforcement, material selection, anchoring systems, windborne debris protection, and storm load calculations for new construction, retrofitting, and infrastructure projects. In embodiments, hurricane codes may refer to the International Building Code (IBC), Section 1609, which establishes wind load criteria and structural anchoring requirements, the ASCE 7—Minimum Design Loads and Associated Criteria for Buildings and Other Structures, which defines hurricane wind loads, uplift forces, and structural reinforcement criteria, and the ICC 600-Standard for Residential Construction in High-Wind Regions, for designing and constructing residential buildings to withstand hurricane-force winds. Additional applicable codes may include the Florida Building Code (FBC), Section 1609, which sets forth wind resistance and impact-resistant construction requirements, the High-Velocity Hurricane Zone (HVHZ) standards, which apply to Miami-Dade and Broward counties and mandate enhanced structural reinforcement, and the Texas Department of Insurance (TDI) Windstorm Building Code Requirements, which regulate wind-resistant construction in coastal regions. Other relevant standards may include the Louisiana State Uniform Construction Code (LSUCC), Section 301.2.1.1, which requires compliance with ASCE 7 for wind resistance, the North Carolina Residential Code, Section R301.2.1, which establishes windborne debris protection standards, and the South Carolina Building Code, Chapter 16, which defines wind-resistant design and roof tie-down requirements. Further references may include the Alabama State Building Code, Section 1609, the Mississippi Coastal Retrofit Program Requirements, FEMA P-320 and P-361 guidelines for hurricane-resistant construction and storm shelters, and the National Flood Insurance Program (NFIP) Coastal Construction Standards, to name a few.

The definitions provided herein are intended for clarity and consistency in describing the invention but should not be construed as limiting. While specific examples, embodiments, and materials are described, the invention is not restricted to these particular implementations. Instead, the disclosed embodiments are illustrative and various modifications, substitutions, and equivalents may be used without departing from the spirit and scope of the invention, as would be understood by one skilled in the art.

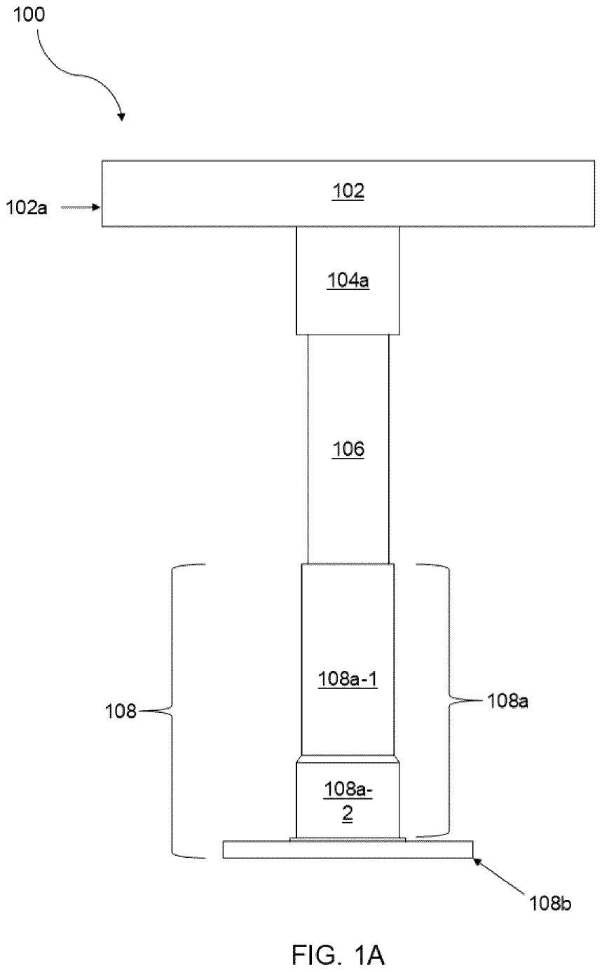

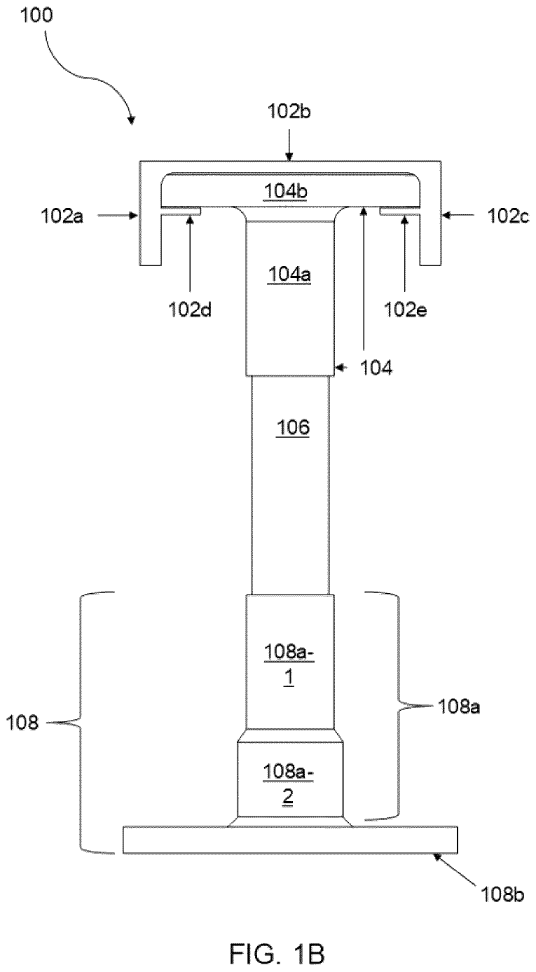

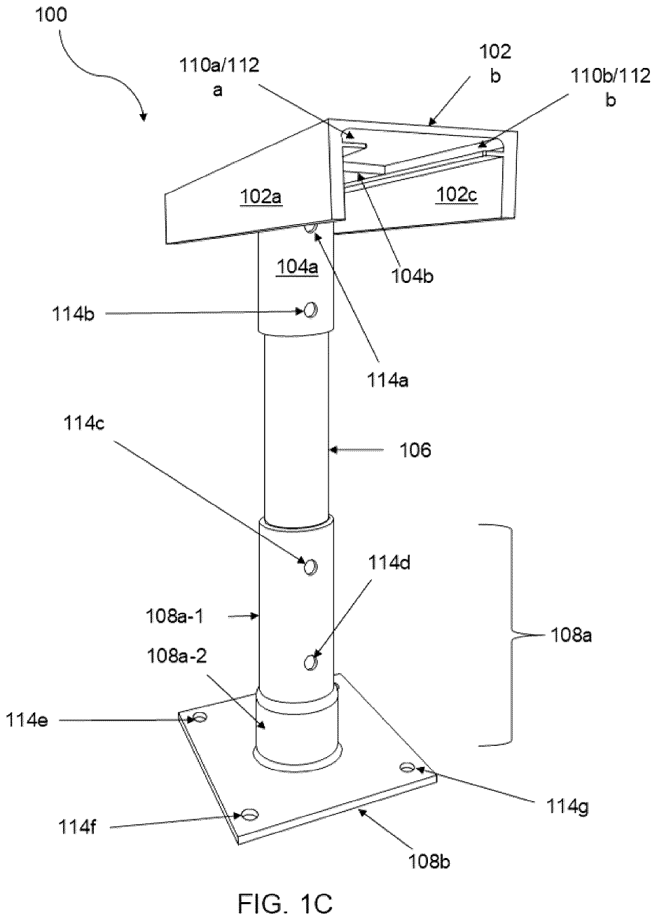

Referring now to FIGS. 1A, 1B, and 1C, illustrated are front, side, and perspective views, respectively, of a multi-configuration, modular apparatus 100, in accordance with various embodiments of the present invention. Multi-configuration, modular apparatus 100 is a field-deployable, pre-engineered support system composed of discrete modular components designed to be easily shipped, easily, safely, and rapidly assembled, and easily, rapidly, and safely installed. Multi-configuration, modular apparatus 100, in embodiments, may be fabricated from extruded aluminum or, in some embodiments, alternative materials such as stainless steel, carbon fiber composites, or galvanized steel, to name a few, depending on the desired balance of weight, corrosion resistance, and load capacity. Components of multi-configuration, modular apparatus may, in embodiments, include Schedule 40 piping and Schedule 80 piping.

In embodiments, multi-configuration, modular apparatus 100 comprises a top support 102, a top connector 104, a vertical column 106, and a baseplate 108. Each of these components may be mechanically coupled via pressure fitting and/or other coupling mechanisms. The pressure-fit design, in embodiments, facilitates tool-free or low-tool assembly, improving worker safety and reducing labor costs. In embodiments, the mechanical coupling of each component will reduce or eliminate the need for on-site welding or permanent modification, improving worker safety and reducing labor costs.

Top support 102, in embodiments, comprises a horizontal section 102b, a first vertical section 102a, and a second vertical section 102c, forming a substantially U-shaped structural profile. In embodiments, extending substantially perpendicularly from first vertical section 102a is a first channel extrusion 102d. First channel extrusion 102d, along with first vertical section 102a and horizontal section 102b, define first channel 110a. In embodiments, extending substantially perpendicularly from second vertical section 102c is a second channel extrusion 102e. Second channel extrusion 102e, along with second vertical section 102c and horizontal section 102b, define second channel 110b. In embodiments, first channel 110a and second channel 110b are configured to receive horizontal section 104b of top connector 104 in a pressure-fit relationship. A pressure-fit relationship, in embodiments, forms a stable and rigid interface between top connector 104 and top support 102.

Top connector 104, in embodiments, comprises vertical section 104a and horizontal section 104b, forming, in embodiments, a T-shaped profile depending on orientation. Horizontal section 104b is, in embodiments, substantially rectangularly shaped and dimensioned to slide into the opposing extruded channels 102d and 102e, thereby mating with the top support 102. In embodiments, horizontal section 104b is shaped differently than substantially rectangularly without compromising the structural integrity and use of multi-configuration, modular apparatus 100. For example, horizontal section 104b may be oval or oblong in shape, to name a couple.

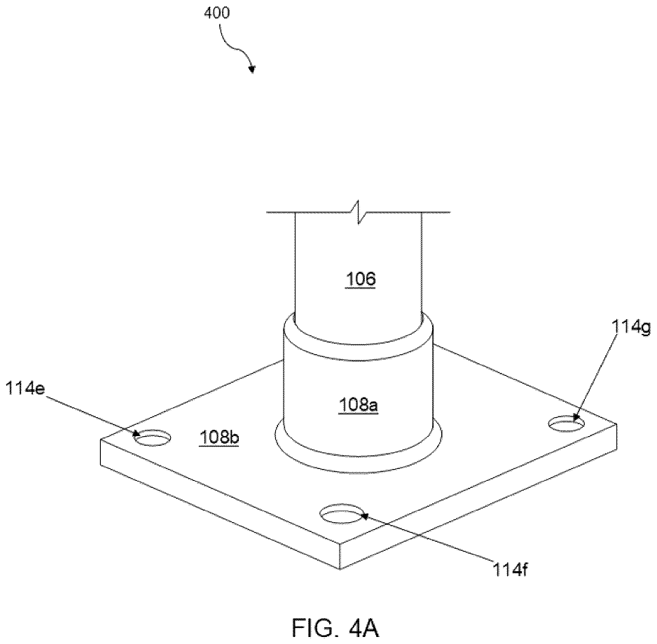

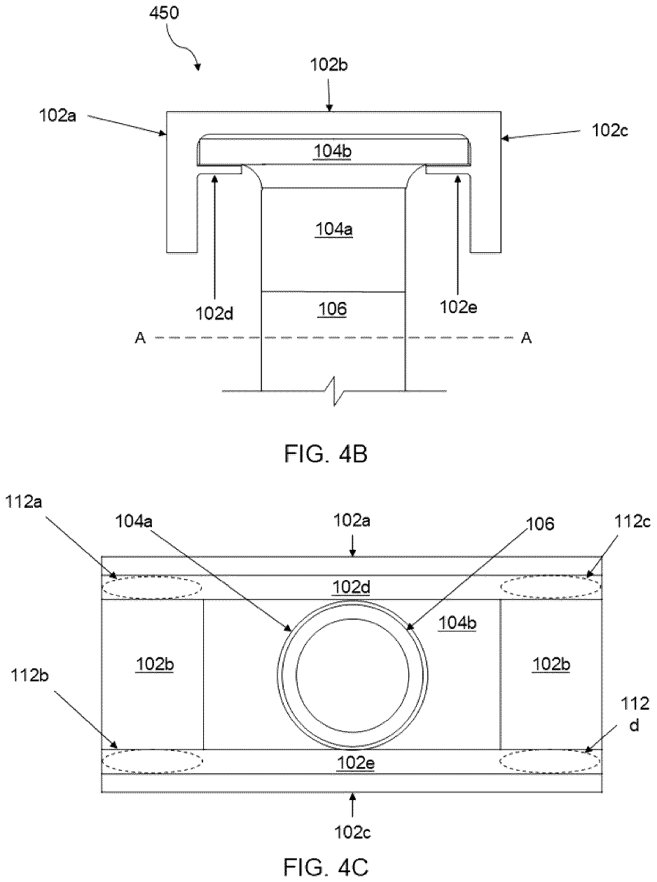

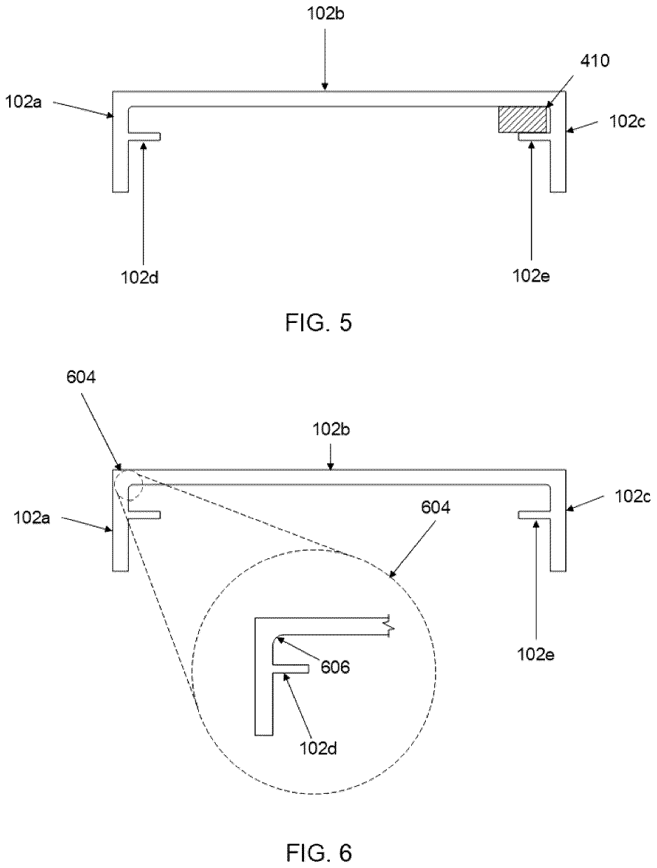

In embodiments, horizontal section 104b does not fully fill first and second channels 110a/110b, defining a first gap 112a and second gap 112b, respectively. In embodiments, third and fourth gaps on the opposite end of top connector 104 and top support 102 exist. The descriptions of first gap 112a and second gap 112b may be similar to that of the third gap 112c and the fourth gap 112d (shown and described in connection with FIG. 4C) respectively, the descriptions of which applying therein. These gaps are configured to receive one or more lock blocks 410, as described in greater detail in connection with FIG. 5, and 9A-9B. In some embodiments, the inclusion of lock block 410 allows for minor adjustments to top support 102, enabling safe, tool-free or low-tool adjustments during installation.

Vertical column 106 is in embodiments, a tubular structure designed to interface with both top connector 104 and baseplate 108 via mechanical coupling, such as, for example, a press-fit engagement. In embodiments, vertical column 106 is fabricated from extruded aluminum for lightness and strength, although stainless steel, galvanized steel, or high-performance thermoplastics suitable for the application of multi-configuration apparatus 100 may also be used individually, or one or more combinations. The tubular profile of vertical column 106 allows for efficient axial load transfer while minimizing weight.

In embodiments, baseplate 108 includes a vertical section 108a and a horizontal section 108b. In some embodiments, vertical section 108a comprises a top vertical section 108a-1 and a bottom vertical section 108a-2 with differing thicknesses or radii, forming a stepped or tapered bore. This stepped design, in embodiments, may allow vertical column 106 to be received securely and concentrically while preventing over-insertion of vertical column 106, enabling repeatable installation depth and axial alignment. Horizontal section 108b, in embodiments, is generally rectangular in plain view and includes a plurality of apertures 114e-114g for fastening the baseplate to a surface using bolts, anchors, or other fasteners. In some embodiments, apertures 114a-114d are also defined through vertical column 106 and vertical section 108a, enabling optional cross-bolting to secure the vertical column within the baseplate. Where fasteners such as bolts 312a and washers 314a are used, nylon washers or bushings may be incorporated to mitigate galvanic corrosion and wear, particularly when dissimilar materials (e.g., aluminum and stainless steel) are used. The use of nylon also prevents metal-on-metal contact that can lead to galling or loosening due to thermal cycling. In embodiments, horizontal section 108b is shaped differently than rectangular in plain view without compromising the structural integrity and use of multi-configuration, modular apparatus 100. For example, horizontal section 108b may be oval or oblong in shape, to name a couple.

Referring specifically to FIG. 1A, a front view of multi-configuration, modular apparatus 100 is shown. The front view illustrates top support 102, vertical column 106 with top connector 104 and baseplate 108. Vertical section 104a of top connector 104 is shown received within the top of vertical column 106, and vertical column 106 is shown received within vertical section 108a of baseplate 108. FIG. 1A illustrates a stepped engagement of vertical section 108a-1 and 108a-2 enables a concentric, secure fit without requiring field modifications. The stepped engagement, in embodiments, is not required. Apertures 114a, 114b, 114c, and 114d are visible and, in embodiments, may align with corresponding apertures in the vertical column to allow for optional bolt-through coupling.

Referring now to FIG. 1B, a side view of multi-configuration, modular apparatus 100 is provided. This view shows the U-shaped profile of top support 102, with vertical sections 102a and 102c extending downward from horizontal section 102b. First and second channel extrusions 102d and 102e, respectively, in embodiments, come together with the remainder of top support 102 to define channels 110a and 110b into which horizontal section 104b of top connector 104 may be inserted. The ends of horizontal section 104b terminate short of the channel depth, leaving first gap 112a, second gap 112b, third gap 112c (shown and described in connection with FIG. 4C), and fourth gap 112d (shown and described in connection with FIG. 4C). One or more of the gaps described may receive lock block 410 for enhanced stability. This configuration minimizes torsional play and improves alignment during installation, solving a common issue in field-fabricated piping support systems. Multi-configuration, modular apparatus 100 is also configured to help ensure repeatability in shipping, assembly, and installations.

In embodiments, as illustrated by FIGS. 1A, 1B, and 1C, baseplate 108b is shown lying flush with the mounting surface and includes apertures 114e-114g for mechanical anchoring. The illustrated layout, in embodiments, is engineered to distribute loads uniformly across the support footprint, preventing point loads that could damage flooring or structural sub-surfaces.

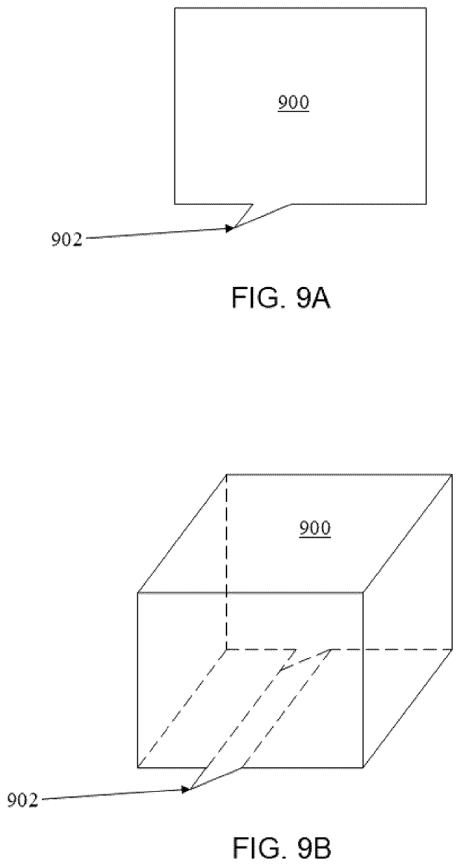

Referring to FIG. 1C, a perspective view of multi-configuration, modular apparatus 100 further reveals the geometric relationships between top support 102, top connector 104, vertical column 106, and baseplate 108. The U-shaped structure of the top support and the sliding engagement of horizontal section 104b into channel extrusions 102d and 102e are clearly visible. Also apparent are the first and second gaps 112a and 112b between horizontal section 104b and the channels, which receive lock blocks 410. The lock blocks may include protrusions 902 to prevent sliding or displacement once installed. In embodiments, the third and fourth gaps mirror the first and second gaps 112a and 11b respectively on the opposite end of top support 102 and top connector 104. Lock blocks are described more fully in FIGS. 5, 9A, and 9B, the describes of which applying herein.

Also illustrated in FIG. 1C are apertures 114a, 114b, 114c, and 114d extending through vertical column 106 and vertical section 108a, which may receive bolts or pins for additional mechanical coupling. Fasteners such as bolts 312a and washers 314a may be used to secure baseplate 108 to a surface. In embodiments, nylon washers and/or bolts, may be utilized. Nylon washers and/or bolts in this context reduce wear and provide dielectric isolation between dissimilar metals, supporting long-term durability in corrosive or outdoor environments.

In embodiments, the overall shape and size of each component are optimized for compact shipping, field handling, and job site safety and efficiency. In embodiments, the pre-assembled, shipped, and fully assembled multi-configuration, modular apparatus 100 may each weigh less than 100 pounds, enabling manual lifting, placement, and repositioning by a two-person crew without the need for cranes, forklifts, or overhead hoists. This significantly reduces labor costs and eliminates heavy-equipment-related access challenges often encountered in constrained or elevated environments.

In some embodiments, where lightweight materials such as extruded aluminum and carbon-fiber-reinforced composites, to name a few, are used, the overall weight of multi-configuration, modular apparatus 100 may be reduced to as little as 50 to 70 pounds, while still supporting industrial loads of 1,000 pounds or more. This yields a load-to-weight ratio of 14:1 to 20:1, which significantly exceeds the performance of traditional steel support structures that may weigh over 200 pounds while offering comparable or even inferior load capacity. For example, a configuration using aluminum 6061-T6 tubing for the vertical column and top connector, combined with cast or extruded aluminum for the baseplate and top support, may weigh under 80 pounds yet maintain 1,500+ pounds of distributed load capacity, depending on geometry and anchoring.

In embodiments where greater resistance to impact, vibration, or harsh chemicals is required, heavier materials such as stainless steel or Schedule 80 galvanized pipe may be used, increasing the system's weight to the 90-100 pound range while providing enhanced rigidity and environmental durability. The design and configuration of multi-configuration, modular apparatus 100, in embodiments, prioritizes a favorable balance between transportability and structural performance, allowing for deployment in remote, elevated, or difficult-to-access areas without specialized equipment or infrastructure.

The increased flexibility provided by multi-configuration, modular apparatus 100 addresses major cost and logistical burdens noted in the background—reducing shipping volume and cost, allowing for staging near the point of installation, and improving worker safety during setup, installation, and, if necessary, teardown. These advantages make the apparatus suitable for many environments, such as rooftop HVAC installs, refinery catwalk supports, utility trench infrastructure, and other demanding environments, to name a few, where structural integrity and ease of deployment are critical.

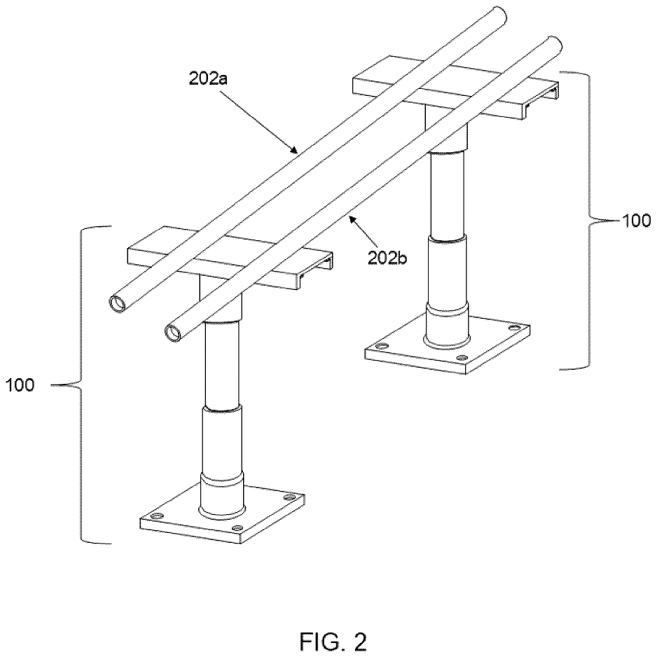

Referring now to FIG. 2, illustrated is a perspective view of a plurality of multi-configuration, modular apparatuses 100 arranged in parallel to support a plurality of loads, including, for example, loads 202a and 202b, in accordance with various embodiments of the present invention. Each multi-configuration, modular apparatus 100 in the illustrated arrangement is configured substantially in the manner described above with reference to FIGS. 1A-1C, including top support 102, top connector 104, vertical column 106, and baseplate 108. In embodiments, each apparatus is modular and independently positionable, allowing for customized installation spacing based on the length, diameter, and weight distribution of the supported load, to name a few. While only two multi-configuration, modular apparatuses 100 are shown, configurations of multi-configuration, modular apparatuses 100 may include more than two multi-configuration, modular apparatuses 100, depending on installation requirements.

In embodiments, loads 202a and 202b may include industrial piping, electrical conduit, steam lines, chemical lines, and HVAC distribution systems, to name a few. In embodiments, each multi-configuration, modular apparatus 100 is configured to support heavy loads (e.g., over 1,000 pounds) to be supported without requiring permanent anchors or cast-in-place concrete footings. This modular flexibility is particularly beneficial in temporary construction environments, pipe bridge applications, or remote infrastructure where field welding and precise alignment are impractical or hazardous.

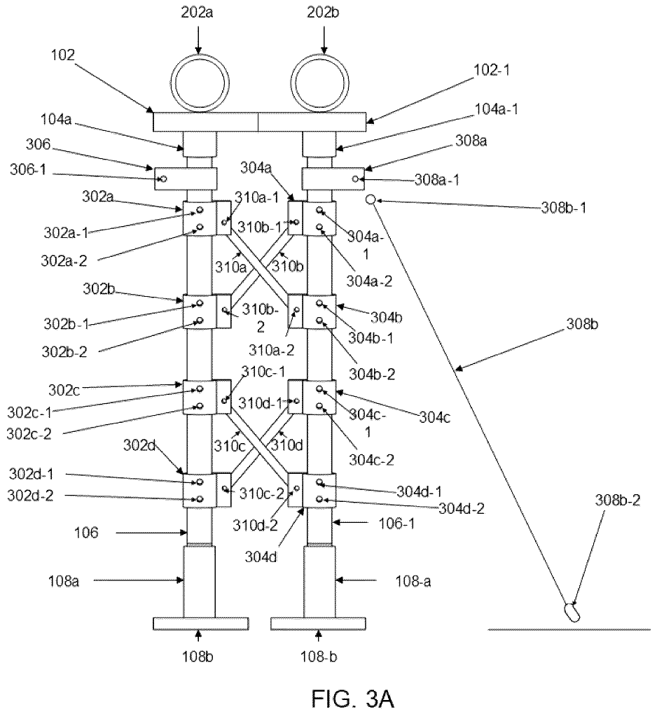

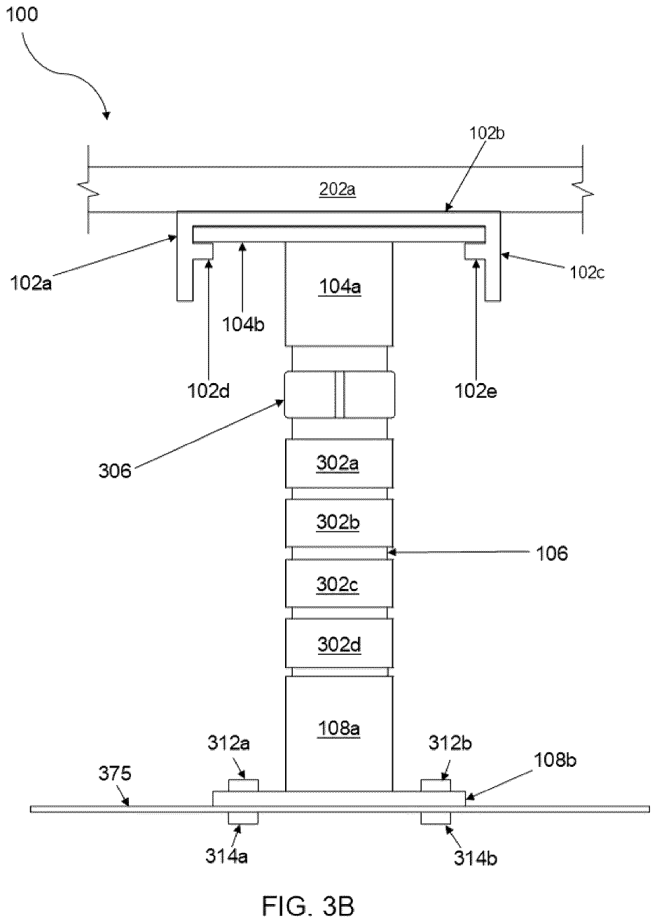

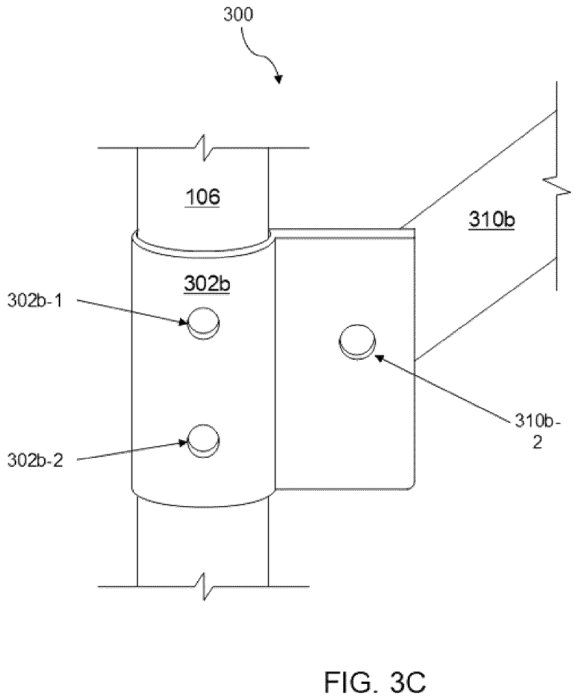

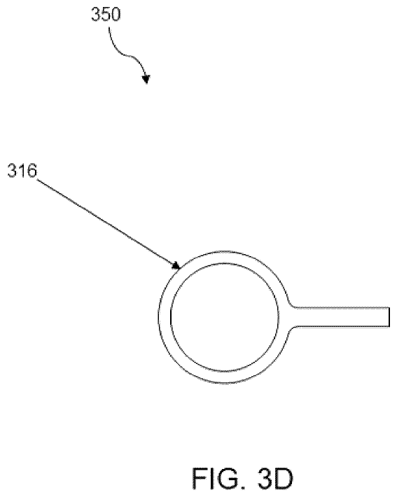

In the illustrated embodiment, the spacing between and positioning of multi-configuration, modular apparatuses 100 may be varied to support loads with non-uniform weight distribution, to accommodate seismic bracing elements and to accommodate thermal expansion joints in the piping system, to name a few. The pressure-fitted vertical columns 106, in embodiments, ensure axial alignment and resist torsional movement during service. When the supported loads (e.g., loads 202a and 202b) require secure restraint or anti-lift protection, additional fasteners or cross-member supports (e.g., elements like 310a-310d described below in connection with FIGS. 3A, 3B, 3C, and 3D, the descriptions of which applying herein) may be introduced. Additional fasteners or cross-member supports can mechanically link adjacent apparatuses for added lateral stability, impact resistance, and code compliance under hurricane or earthquake loading scenarios, to name a few.

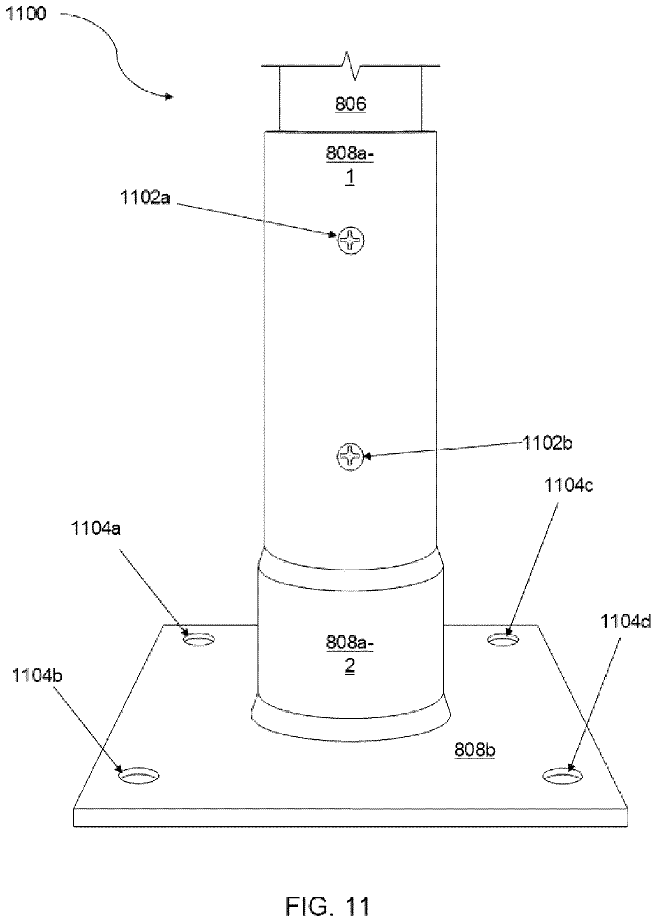

In embodiments, multi-configuration, modular apparatuses 100 are deployed on finished concrete, rooftop platforms, or structural decks without the need for additional embedded anchors. In embodiments, fasteners such as bolts 312a and washers 314a (not shown in this figure but described in FIGS. 3A, 3B, 3C, 3D, and 11, the descriptions of which apply herein) may be used to secure baseplates 108 to a surface. Where required, in embodiments, nylon washers may be used to prevent galvanic corrosion between stainless steel fasteners and aluminum components, increasing system longevity in coastal or chemically exposed

The modularity shown in FIG. 2 supports logistical efficiency: components can be pre-packed, flat-stacked, and shipped in compact units, reducing transport volume and enabling installers to assemble and install multiple multi-configuration, modular apparatuses 100 with minimal on-site fabrication. This not only reduces time and cost, but also minimizes the potential for worker injury due to hot work, overhead welding, or heavy lifting. In embodiments, enabling manual placement of each multi-configuration, modular apparatus 100 and accommodating multiple piping configurations, the system of multiple multi-configuration, modular apparatuses 100 addresses the longstanding need for safer, standardized, and adaptable overhead pipe support in industrial and commercial environments.

Referring now to FIGS. 3A and 3B, illustrated are multiple views of a modular configuration system and apparatus involving a plurality of multi-configuration, modular apparatuses 100 and 100-1, used together to support a plurality of industrial loads, such as industrial piping. These figures illustrate an example of how multiple multi-configuration, modular apparatuses 100 and 100-1 may be deployed and mechanically joined for greater span, load capacity, distributed load sharing, and system-wide stabilization, to name a few. In embodiments, loads such as first load 202a and second load 202b are supported atop respective top supports 102 and 102-1 of multi-configuration, modular apparatuses 100 and 100-1, respectively. In embodiments, multi-configuration apparatus 100-1 and all its components are similar to multi-configuration apparatus 100 and all its components described throughout, all of the descriptions apply herein.

Referring now to FIG. 3A, illustrated is a front view of a system comprising a pair of multi-configuration, modular apparatuses 100 and 100-1, each supporting a corresponding industrial load 202a and 202b, in accordance with various embodiments of the present invention.

In the embodiment shown, each multi-configuration, modular apparatus 100 and 100-1 includes top support 102 and 102-1, top connector 104 and 104-1 (including vertical sections 104a and 104a-1), vertical columns 106 and 106-1, and baseplates 108 and 108-1, respectively. Top supports 102 and 102-1 are shown oriented in parallel and supporting industrial loads. Top connectors 104 and 104-1 each include vertical sections (104a, 104a-1) that connect to vertical columns 106 and 106-1. The horizontal and vertical planes associated with lining up each multi-configuration, modular apparatus 100 and 100-1 may vary based on, for example, load weight, installation requirements, and environmental conditions, to name a few.

Each vertical column (106, 106-1) includes a series of coupling elements 302a, 302b, 302c, and 302d on multi-configuration, modular apparatus 100 and 304a, 304b, 304c, and 304d on multi-configuration, modular apparatus 100-1. Each coupling element includes one or more apertures (e.g., 302a-1, 302a-2, 302b-1, 302b-2, 302c-1, 302c-2, 302d-1, 302d-2, 304a-1, 304a-2, 304b-1, 304b-2, 304c-1, 304c-2, 304d-1, 304d-2) to receive fasteners or alignment pins. These apertures may be used for attaching lateral structural elements, for example cross-members 310a, 310b, 310c, and 310d.

Each cross-member (e.g., 310a, 310b, 310c, 310d) is operably coupled between the opposing vertical columns (106, 106-1), providing lateral stability and distribution of torsional and seismic forces. Each cross-member includes apertures at its endpoints (310a-1, 310a-2, 310b-1. 310b-2, 310c-1, 310c-1, 310d-1, 310d-2) for secure coupling using fasteners such as bolts and nuts. In embodiments, fewer or additional cross-members may be employed—one, two, three, four, or more—depending on environmental conditions, load weight, desired redundancy, or local code requirements. Cross-members may be arranged in a crisscross “X” configuration (as shown), in parallel, or staggered across multiple vertical or horizontal planes to improve rigidity, enable offset load configurations, or avoid interfering with other on-site structures or conduit.

In embodiments, additional support member 306 is affixed to vertical column 106 and 308a is affixed to vertical column 106-1. Each additional support member (306 and 308a), in embodiments, includes at least one aperture (306-1 and 308a-1 respectively). In embodiments, support member 306 and support member 308a are designed to enhance the stability of the modular support system by providing lateral bracing or anchoring the apparatus to adjacent structures, including walls, slabs, or embedded fixtures, to name a few. In some embodiments, support member 306 may be used alone, or in conjunction with one or more cables, similar to support cable 308b, to create a triangulated or reinforced configuration. Support cable 308b, in embodiments, may be affixed to support member 308a via aperture 308a-1 and end fitting 308b-1 and anchored via end fitting 308b-2. In embodiments, end fittings 308b-1 and 308b-2, may include threaded couplers, looped eyes, turnbuckles, and clevis pins, to name a few, to facilitate adjustable anchoring.

In some embodiments, support cable 308b may be composed of stainless steel for corrosion resistance, galvanized steel for cost-effective strength, aramid fibers such as Kevlar® for high tensile capacity and reduced weight, marine-grade synthetics for environments prone to salt or moisture exposure, and any combination thereof, to name a few. The choice of material, in embodiments, may be selected based on environmental conditions, code requirements, and installation constraints. For instance, in high-humidity or coastal installations, stainless steel or polymer-jacketed cables may be used to extend service life and prevent galvanic corrosion between dissimilar metals.

The number of support cables or braces used may vary depending on anticipated loads, environmental forces, and redundancy requirements, to name a few. One, two, three, or more cables may be included per multi-configuration modular apparatus 100 or between multi-configuration modular apparatus 100 and multi-configuration modular apparatus 100-1, in vertical, angled, and crossed orientations, to name a few. These cables (e.g., support cable 308b) may provide resistance against wind uplift, seismic sway, vibration, and accidental impact, to name a few, and may be pre-tensioned and field-tensioned to a prescribed force to optimize structural engagement, to name a couple. In embodiments, the apparatus may be rated to resist dynamic loads transmitted through the cables in excess of 1,000 pounds, depending on material selection and installation geometry. The modular design of the support members 306 and 306a and cable anchor points (e.g., 308b, 308b-1, 308b-1) facilitates compliance with building codes and industry standards, including ASCE 7 and regional hurricane or seismic bracing requirements.

In embodiments, baseplates 108 and 108-1 each comprise a vertical section (108a and 108-a) and a horizontal section (108b and 108-b), forming an inverted T-shape configuration in profile. Each horizontal section (108b and 108-b) includes apertures for receiving fasteners (shown and described in connection with FIG. 3B, the description of which applying herein). In embodiments, baseplates 108 and 108-1 may be fastened to concrete, metal grating, or decking surfaces using these fasteners and, in embodiments, pressure-fit into the vertical column 106 and 106-1 respectively with or without using stepped internal profiles.

In embodiments, multi-configuration apparatus 100-1 and all its components is similar to multi-configuration apparatus 100 and all its components described throughout; all of the descriptions apply herein. This mirroring of structure and function enables consistent modular design and streamlines production, shipping, and installation while ensuring compatibility across various industrial configurations.

This figure demonstrates the system's ability to scale horizontally, integrate additional bracing mechanisms, and offer highly secure, code-compliant installation options for use in facilities that require resilient and modular support structures for industrial loads such as conduit, chemical piping, ducting, or other mechanical infrastructure.

Referring now to FIG. 3B, illustrated is a side view of the apparatus and system depicted in FIG. 3A, showing a single multi-configuration, modular apparatus 100 supporting an industrial load, such as first and second loads 202a and 202b, in accordance with various embodiments of the present invention. In this side view, only one of the two apparatuses in the system is shown. Load 202a is illustrated resting on top support 102, which transfers the load to the underlying vertical support structure via top connector 104 and vertical column 106. This configuration, in embodiments, is designed to accommodate both symmetrical and asymmetrical load conditions while maintaining lateral and vertical stability.

Top support 102 is shown with horizontal section 102b extending across the top of the apparatus and defining the mounting interface for load 202a. Extruded channel sections 102d and 102e are visible in this view, and in combination with first and second channels 110a and 110b, they securely receive the horizontal section 104b of top connector 104. The connection between horizontal section 104b and channels 110a/110b is pressure-fit in this embodiment, offering secure attachment without the need for field welding or additional hardware.

Vertical column 106 extends downward from vertical section 104a of top connector 104 and provides the main vertical load path. Mounted along the length of vertical column 106 are support member 306 and coupling elements 302a, 302b, 302c, and 302d, each shown clamped, slid, pressure-fitted, and combination thereof, to name a few, to the outer wall of vertical column 106. Support member 306, in embodiments, is configured to enhance the stability of the modular support system by providing lateral bracing or anchoring the apparatus to adjacent structures, including walls, slabs, and embedded fixtures, to name a few. In embodiments, coupling elements 302a, 302b, 302c, and 302d, are configured to allow lateral support connections, including but not limited to cross-members or bracing arms (e.g., 310a, 310b, 310c, 310d). In some embodiments, coupling elements 302a, 302b, 302c, and 302d may be affixed using internal or external threads, mechanical collars, adhesive locking, radial set screws, and a combination thereof, to name a few. The number of coupling elements used—such as one, two, three, four, or more—may be selected based on load characteristics, material stiffness, and the environmental conditions of deployment, to name a few. For example, installations requiring resistance to wind uplift or seismic movement may utilize additional coupling points to ensure structural continuity between multiple apparatuses.

The lower portion of the apparatus includes baseplate 108, comprising vertical section 108a and horizontal section 108b, which anchors the apparatus to the installation surface. Fasteners 312a and 312b extend through the baseplate and are secured with bolts/washers 314a and 314b. In some embodiments, the washers may be composed of nylon or another polymeric material to prevent corrosion or galvanic bonding between dissimilar metals, including in environments where stainless steel fasteners are used in conjunction with extruded aluminum baseplates. The nylon components also serve to dampen vibration, reduce metal fatigue, and extend the service life of the anchoring system under repeated load cycles, to name a few.

FIG. 3B, in embodiments, illustrates the integrated load path from load 202a down through top support 102, top connector 104, and vertical column 106 to the baseplate 108, and ultimately into the surface (e.g., surface 375) via fasteners 312a, 312b, 314a, and 314b. In embodiments, the arrangement of components enables a field-configurable support structure capable of meeting heavy-duty industrial load demands with modular components, minimal tooling, and no hot work, addressing safety, time, and cost concerns highlighted in the Background section of this application.

Referring now to FIG. 3C, illustrated is an enlarged view of a portion 300 of the modular support system depicted in FIGS. 3A and 3B, in accordance with various embodiments of the present invention. This view focuses on the interface between vertical column 106 and cross-member 310b, specifically detailing the coupling mechanism 302b and associated features. The description of coupling element 302b, cross-member 310b, and various other components herein the description of FIG. 3C can apply to each coupling element (302a, 302b, 302c, and 302d) and each cross member (310a, 310b, 310c, and 310d).

As illustrated in FIG. 3C, in embodiments, coupling element 302b is affixed to vertical column 106 and configured to support and secure cross-member 310b. Coupling element 302b may include fastener apertures 302b-1 and 302b-2, through which bolts or other mechanical fasteners may be inserted to attach and stabilize coupling element 302b and cross-member 310b. These apertures (302b-1 and 302b-2), in embodiments are spaced and configured to ensure a strong mechanical connection, distribute shear and torsional loads, and allow for field adjustments during installation.

In embodiments, coupling element 302b may be fabricated from structural steel, anodized aluminum, high-performance polymers, or fiber-reinforced composite materials, depending on the application and environmental exposure. For instance, aluminum and polymer composites may be used in corrosive or marine environments, while steel may be selected for heavy load-bearing applications. The fasteners may be paired with nylon washers or insulators to reduce corrosion from metal-on-metal contact, particularly when the vertical column and coupling are made from dissimilar materials. The cross-member 310b, in embodiments, may be formed from extruded aluminum, stainless steel tubing, or other high-strength structural components, and may serve a variety of functions including lateral stabilization, load distribution, and compliance with seismic or wind code requirements.

This portion of the system illustrates the modularity and structural adaptability of the support assembly, enabling field-deployable stability solutions that reduce or eliminate in-field welding, minimize installation complexity, and improve job site safety—consistent with the problems identified in the Background section of this application.

Referring now to FIG. 3D, illustrated is an enlarged view 350 of an example coupling element 316 configured for attachment to a vertical column (e.g., vertical column 106), in accordance with various embodiments of the present invention. As shown, coupling element 316 defines an interior passage or bore that may be dimensioned to slide over the outer surface of a vertical column such as vertical column 106.

In embodiments, the coupling element 316 may be installed by sliding it downward along the vertical column until a desired elevation is reached, and then secured in place using bolts, pins, clamps, or compression collars. In embodiments, the shape of coupling element 316 may be circular, rectangular, or polygonal, depending on the geometry of the column and desired mechanical engagement.

Although this embodiment illustrates a slide-on configuration, the coupling element 316 may also be clamped externally around the column using split-body brackets and tightening fasteners; threaded onto a column with external threads; pressure-fit with interference tolerance; pinned through apertures in both the column and the element; or bonded using high-strength adhesives or epoxy in permanent or semi-permanent installations.

Coupling elements such as 316 may serve as mounting brackets for cross-members, cable tensioners, or sensor units, and can be made from structural-grade steel, aluminum alloys, and engineered polymers, to name a few, depending on the application environment and required load tolerance, to name a few.

Referring now to FIG. 4A, illustrated is an enlarged view of a lower portion 400 of multi-configuration, modular apparatus 100. Lower portion 400, as illustrated in FIG. 4A, focuses on the interface between vertical column 106 and baseplate 108, in accordance with various embodiments of the present invention.

As illustrated in FIG. 4A, in embodiments, vertical column 106 is received into vertical section 108a of baseplate 108, accommodating a pressure-fit, which in turn is supported by horizontal section 108b. In some embodiments, vertical section 108a includes a stepped bore (not visible in this particular view but described elsewhere) to further accommodate pressure-fitting of vertical column 106. Pressure-fit components, and other mechanical coupling, may enable secure, non-welded installation in the field, reducing the need for hot work or precise cutting and improving safety and speed of deployment.

The baseplate 108 is anchored to the supporting surface using one or more apertures 114e, 114f, and 114g, which may be configured to receive fasteners, bolts, or ground anchors. These apertures are strategically spaced across the horizontal section 108b to distribute anchoring loads and provide rotational and shear resistance under high-stress operating conditions. In some embodiments, fasteners inserted into these apertures are used in combination with nylon or polymer washers to mitigate corrosion due to galvanic effects and to isolate metal-on-metal contact between dissimilar materials, such as aluminum and stainless steel. Nylon or polymer, in embodiments, enhances long-term durability, especially in environments with temperature variation or moisture ingress.

The location and number of anchoring apertures (e.g., three are shown in FIG. 4A, the fourth located near the unshown corner of baseplate 108) may vary depending on installation codes or structural demands. For example, in installations on concrete pads or elevated platforms, additional apertures may be present to accommodate seismic anchoring bolts, chemical anchors, and epoxy-set threaded rods, to name a few. In embodiments, for temporary or mobile installations, fewer anchors may be used, and alternative anchoring hardware like toggles, spikes, and sandbag brackets, to name a few, may be employed.

Referring now to FIG. 4B, illustrated is an enlarged view of an upper portion 450 of multi-configuration, modular apparatus 100. Lower portion 450, as illustrated in FIG. 4B, focuses on the interface between vertical column 106, top connector 104, and top support 102, in accordance with various embodiments of the present invention.

As illustrated in FIG. 4B, top support 102 includes horizontal section 102b, flanked on either side by first vertical section 102a and second vertical section 102c, together forming a generally U-shaped profile. Extending substantially perpendicular from first vertical section 102a is first channel extrusion 102d. Extending substantially perpendicular from second vertical section 102c is second channel extrusion 102e, which, along with top support 102, define first channel 110a and second channel 110b. In embodiments, first channel 110a and second channel 110b are configured to receive horizontal section 104b of top connector 104.

Top connector 104 includes vertical section 104a, which extends downward and interfaces with vertical column 106. In this view, in embodiments, horizontal section 104b is depicted as being inserted laterally into first channel 110a and second channel 110b, forming a pressure-fit connection that secures top support 102 to vertical column 106 via top connector 104. In embodiments, this configuration, assembly, and installation is designed to be completed without the need for welding or complex fastening. In embodiments, multi-configuration, modular apparatus 100 is configured for rapid, safe, and economical shipping, assembly, and installation in the field with minimal tools and no hot work. The pressure-fit tolerance may be tailored depending on material—e.g., tighter for aluminum components, looser for galvanized or powder-coated steel.

Referring now to FIG. 4C, a bottom-up view along cross-section A-A of FIG. 4B is provided, highlighting additional perspectives of the mechanical fitment between top support 102 and vertical column 106 via top connector 104, in accordance with various embodiments of the present invention.

Cross section A-A, illustrated in FIG. 4C, emphasizes the symmetrical U-shaped geometry of top support 102, including first vertical section 102a, horizontal section 102b, and second vertical section 102c. The extruded channels 102d and 102e are visible from beneath, each forming a recessed rail or sleeve along the inner face of the U-shape. The horizontal section 104b of top connector 104 is inserted snugly within these channels, forming a robust mechanical engagement. Further illustrated are first gap 112a, second gap 112b, third gap 112c, and fourth gap 112d, located between horizontal section 104b of top connector 104 and either end of top support 102. In embodiments, lock-blocks (e.g., lock-block 410 and lock-block 900) may be installed along gaps (e.g., are first gap 112a, second gap 112b, third gap 112c, and fourth gap 112d) in first channel 110a and second channel 110b.

Vertical column 106 is again shown extending downward from the assembly. The vertical section 104a of top connector 104 provides a rigid interface between horizontal section 104b and the top end of vertical column 106, enabling consistent vertical load transfer.

In some embodiments, the material properties of the interacting components—e.g., coefficient of friction, elasticity modulus, or surface finish—are selected to balance ease of installation with long-term structural integrity. In embodiments, optional retention features such as lock pins, cross bolts, or even spring-loaded inserts may be used in addition to or instead of pressure-fitting, depending on load conditions or code compliance needs. Multi-configuration, modular apparatus 100 is configured to support safe and adaptable deployment across a range of installation environments.

Referring now to FIG. 5, illustrated is a side view of top support 102, showing the relationship between structural components and the lock block 410, in accordance with various embodiments of the present invention.

Top support 102 includes first vertical section 102a, horizontal section 102b, and second vertical section 102c, forming a generally U-shaped structure. Extending from the inner walls of horizontal section 102b are first channel extrusion 102d and second channel extrusion 102e, which, along with top support 102, define first channel 110a and second channel 110, which, as described above, are configured to receive the horizontal section 104b (not shown in this view) of top connector 104. In embodiments, first channel 110a and second channel 110 form a nested engagement zone when connector 104 is inserted. In embodiments, the depth of horizontal section 102b of top support 102 is greater than the depth of horizontal section 104b of top connector 104. In such embodiments, the difference in depth creates one or more axial gaps, which may include first gap 112a, second gap 112b, third gap 112c, and fourth gap 112d (not shown)—between the inserted connector and the terminal ends of the extrusions.

Lock blocks 410 provide adjustability during installation, allowing for fine-tuning of the connector's position along the horizontal axis within top support 102. This enables field crews to compensate for minor job site irregularities, non-level terrain, or asymmetric loads. For example, on sloped or uneven roof decks, or when interfacing with other pre-installed mechanical systems, a technician may shift top connector 104, top support 102, or both slightly within the extrusion channels to establish optimal level alignment. Once positioned, in embodiments, lock block 410 is inserted into one or more of the defined gaps to prevent migration or loosening of the joint over time.

Although only one lock block 410 is illustrated in FIG. 5, in some embodiments, one, two, three, or all four of the axial gaps (112a-112d) may be used to house one or more lock blocks 410, depending on the direction and degree of adjustment required. For heavy mechanical loads, redundant locking blocks may be installed at opposing ends to equalize load distribution and reduce creep or deflection. In lighter duty or more mobile installations, only one or two lock blocks may be used to preserve flexibility or allow for later reconfiguration.

In embodiments, lock block 410 may span across two or more axial gaps (e.g., 112a to 112b, or 112c to 112d), thereby engaging with opposing channel sections of top support 102. In such embodiments, lock block 410 may be configured to slide into first channel 110a at one end and second channel 110b at the opposite end, effectively bridging the internal cavity formed between extruded channel structures 102d and 102e of horizontal section 102b. The overall geometry of lock block 410—its width, depth, and height—may be tailored such that the block is retained via interference or pressure fit with features of top support 102 (e.g., first vertical section 102a, horizontal section 102b, second vertical section 102c, first channel extrusion 102d, second channel extrusion 102e), top connector 104 (e.g., horizontal section 104b), or both.

In some embodiments, lock block 410 may further comprise one or more apertures to enable mechanical fastening once inserted. These apertures may be located on various faces or ends of the lock block to accommodate different installation constraints or mechanical requirements. For example, the apertures may be formed on: a proximal end of a horizontal side, a center region of the horizontal side, a distal end of the horizontal side, a first vertical side, a second vertical side, or any combination of thereof.

The apertures may extend in various orientations—vertically (e.g., from the top surface to the bottom surface of the horizontal side) or laterally (e.g., from one vertical side through to the opposite vertical side). This flexibility allows for locking hardware to engage from above, below, or across the width of the lock block.

In some embodiments, top support 102 may also include corresponding apertures on one or more of its structural portions—such as the vertical sections 102a or 102c, horizontal section 102b or within channel extrusions 102d and 102e—that align with the apertures of lock block 410. This alignment enables the use of mechanical fasteners, such as threaded screws, bolts with captive nuts, dowel pins, rivets, or tension-set pins, to further secure the lock block and prevent slippage due to vibration, thermal cycling, or mechanical load. In other embodiments, quick-release pins or detent-based fasteners may be used to enable reconfigurability and facilitate tool-less adjustment during field deployment.

These configurations enhance the overall stability of the top support 102 and top connector 104, particularly in load-bearing scenarios or installations subject to dynamic forces, while preserving modularity and installation flexibility.

In various embodiments, lock block 410 is positioned in one or more of these gaps to secure top connector 104 within top support 102. Lock block 410, in embodiments, may be composed of metal, high-durometer polymer, reinforced composite materials, and a combination thereof, to name a few. In embodiments, lock block 410 may be dimensioned to friction fit or mechanically engage via threaded inserts, pins, or detents.

The modularity of this lock block design supports field adaptability, fast installation, and improved structural stability, particularly in environments where adjustments during installation are required, precision welding is not viable, or where equipment must be demounted and reused at different locations.

Referring now to FIG. 6, illustrated is a close-up perspective view of a portion of top support 102, in accordance with various embodiments of the present invention. This figure focuses on structural details relevant to enhancing the pressure-fit interface between top support 102 and top connector 104.

Portion 604 of top support 102 includes rounded edge 606, which defines an inner surface contour at the junction between the horizontal section 102b and vertical section 102a or 102c. In embodiments, rounded or angled edge 606 serves multiple purposes. For example, rounded edge 606 provides a lead-in feature that may guide the insertion of horizontal section 104b of top connector 104 into first channel 110a and second channel 110b. In embodiments, rounded edge 606 is configured to reduce the risk of jamming or misalignment during insertion of horizontal section 104b of top connector 104, supporting a smoother assembly in field conditions.

In some embodiments, rounded edge 606 may be formed with an angle less than 90 degrees relative to the interior walls of portion 604, such as 80°, 70°, or even 60°, depending on desired insertion tolerance and material flexibility. The tighter the angle, in embodiments, depending on the dimensions of horizontal section 104b of top connector 104 and top support 102, the more effectively rounded edge 606 can serve as a centering or gripping surface, increasing mechanical resistance and stabilizing the pressure fit under both static and dynamic loading conditions.

In embodiments, the use of an angled or curved transition such as rounded edge 606 may accommodate material deformation or thermal expansion, as with, for example, aluminum, stainless steel, and composite extrusions, to name a few. In embodiments, rounded edge 606 may enhance performance in environments subject to vibration, temperature variation, or lateral torsion. The internal geometry of portion 604, in embodiments, may be selectively altered during manufacturing to optimize the pressure-fit interface with horizontal section 104b of top connector 104, which may reduce the risk of loosening over time and improving the load-bearing continuity between joined components.

In embodiments, this internal geometry of top support 102 may enhance stability. In embodiments, the internal geometry of top support 102 may support code compliance by ensuring a snug, vibration-resistant connection without requiring secondary fastening or welding. These structural refinements to multi-configuration, modular apparatus 100 improve field reliability and reduce installation errors, which addresses both safety and economic concerns raised in the Background section.

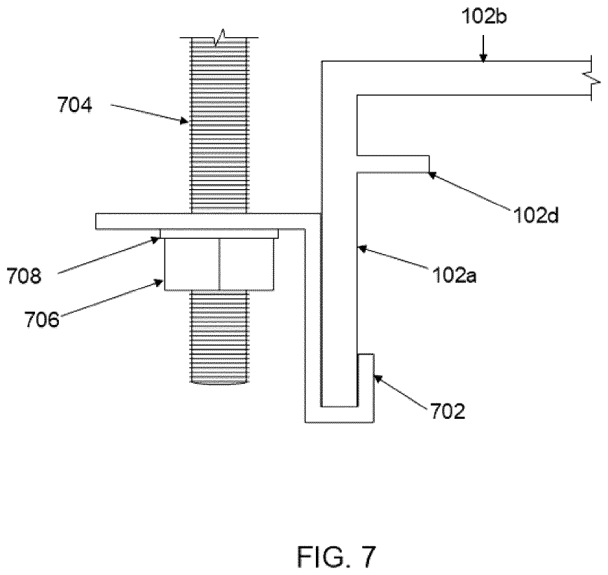

Referring now to FIG. 7, illustrated is a side view of an example configuration showing how multi-configuration, modular apparatus 100 may be anchored to a surface or structure via top support 102, in accordance with various embodiments of the present invention. FIG. 7 illustrates one optional implementation in which the top support 102 is secured, such as to a wall, ceiling, beam, or superstructure.

In the depicted embodiment, top support 102 includes first vertical section 102a, horizontal section 102b, and first channel extrusion 102d, as described in connection with earlier figures. The anchoring system comprises threaded fastener 704, which passes through anchoring bracket 702 and is secured to anchoring bracket 702 via washer 708 and nut 706. The anchoring system, in embodiments, secures top support 102 to a surface via anchoring bracket 702. Anchoring bracket 702 may be shaped to conform to the outer surface of vertical section 102a and may include a flat or contoured interior face, allowing for flush engagement or stress distribution depending on application-specific needs.

In some embodiments, threaded fastener 704 may include bolts (e.g., bolt 706), threaded rods, lag screws, washers (e.g., washer 708), expansion anchors, and a combination thereof, to name a few. The manner in which threaded fastener 704 is secured to anchoring bracket 702, in embodiments, may be selected based on the surface composition (e.g., concrete, steel, or wood) and the anticipated loading conditions. In embodiments, additional washers, locknuts, and other retention mechanisms may be employed to prevent loosening due to vibration or environmental cycling. In embodiments, components of the anchoring system, e.g., anchoring bracket 702, may be formed of structural steel, galvanized or powder-coated metals, corrosion-resistant alloys, and a combination thereof, to name a few, depending on deployment conditions, such as outdoor exposure, humidity, or chemical contact.

Anchoring plate 702, in embodiments, may further include recessed or countersunk channels to protect fasteners from physical damage or to allow for flush finishes, which may be beneficial in environments with clearance restrictions or moving parts. The angular orientation and location of anchoring plate 702 may be selected based on whether the top support is subject to upward loading, lateral bracing demands, or both. For example, upward forces due to seismic motion, wind uplift, or unbalanced piping may be resisted by robust anchoring in this upper configuration.

This anchoring approach enables multi-configuration, modular apparatus 100 to be used not only as a free-standing support but also as a hybrid or top-suspended configuration where structural tie-in is advantageous. Such flexibility may be critical in tight mechanical rooms, rooftop arrays, or industrial facilities with space constraints, irregular mounting surfaces, or other architectural limitations. Accordingly, the configuration shown in FIG. 7 supports greater system adaptability and code compliance, particularly in projects requiring above-ground or overhead conduit stabilization.

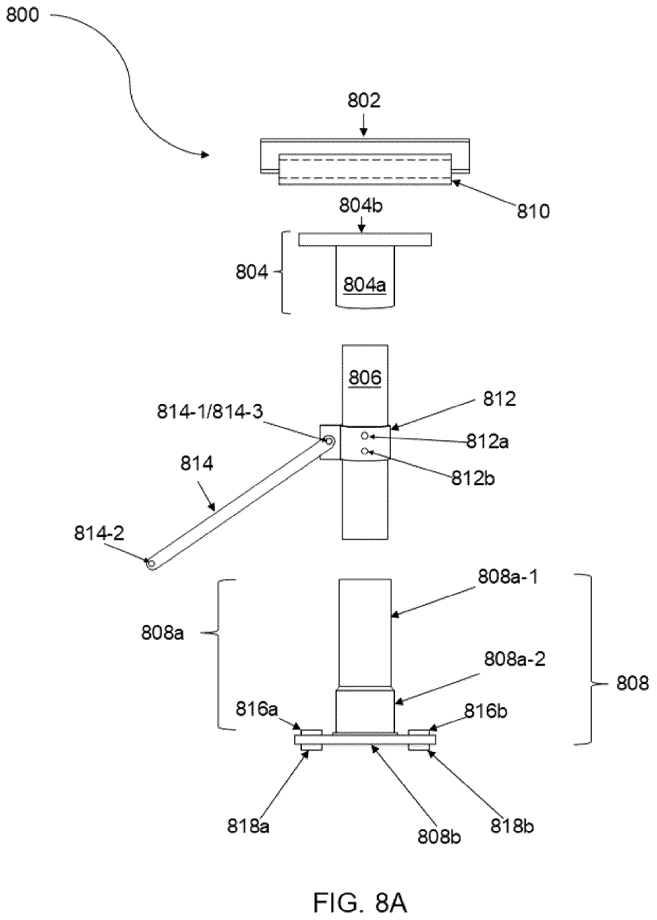

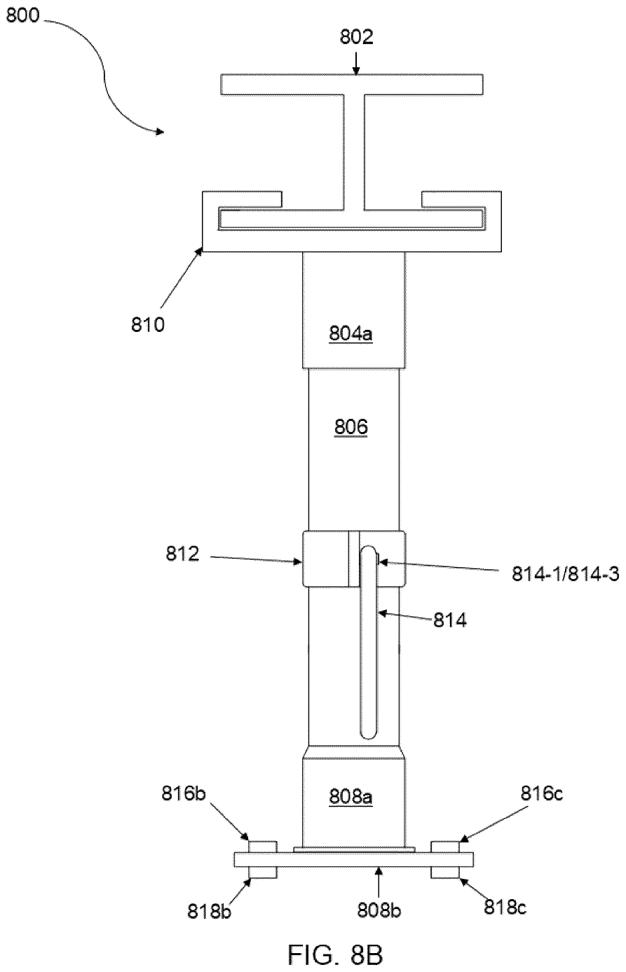

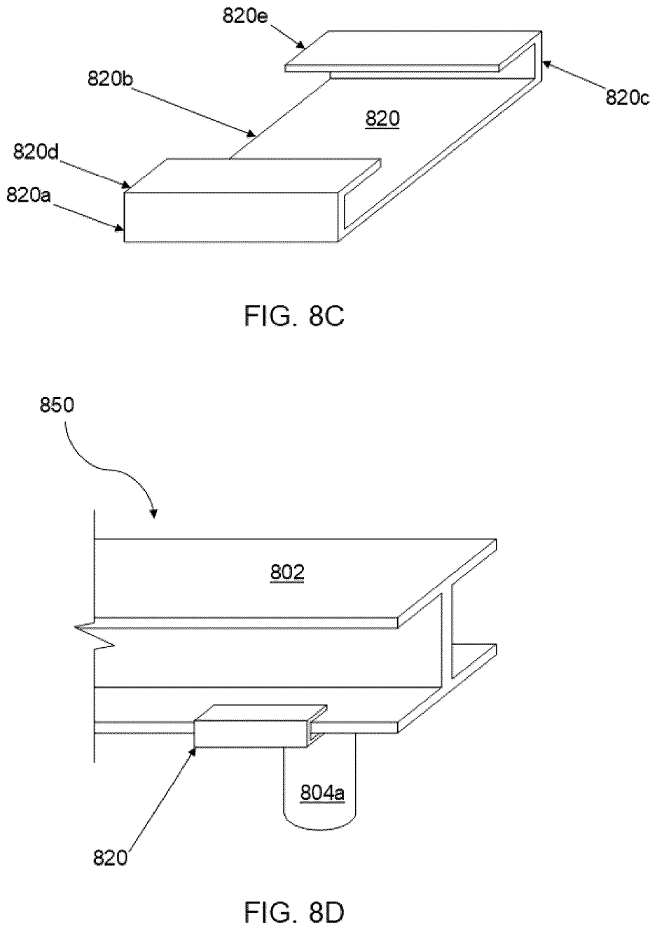

Referring now to FIG. 8A, illustrated is an exploded view of a multi-configuration, modular apparatus 800, in accordance with various embodiments of the present invention. In embodiments, multi-configuration, modular apparatus 800 may include various components similar in structure, geometry, and function to those described with reference to multi-configuration, modular apparatus 100, all descriptions thereof applying herein. Multi-configuration, modular apparatus 800 is configured to support a greater load than multi-configuration, modular apparatus 100, and may be selected for environments requiring higher structural strength, greater span width, or compliance with enhanced code requirements such as for seismic or hurricane zones, to name a few. In embodiments, multi-configuration, modular apparatus 800 comprises baseplate 808, vertical column 806, top connector 804, and I-beam 802, which functions as the top support with a greater load capacity in this embodiment. This view shows the orientation and arrangement of components. Multi-configuration, modular apparatus 800 may include various components similar in structure, geometry, and function to those described with reference to multi-configuration, modular apparatus 100, all descriptions thereof applying herein.

In embodiments, the top support component for multi-configuration, modular apparatus 800 is I-beam 802. In embodiments, I-beam 802 is affixed to top connector 804 via adaptor 810. As shown, adapter 810 is configured to interface between I-beam 802 and top connector 804. In embodiments, adapter 810 includes a pair of opposing channels that are configured to receive the flanges of I-beam 802 (the opposing channels of adapter 810 are described in more detail below in connection with the description of adapter 820 of FIG. 8C, the description of which applying herein). These channels may be similar in geometry and function to first channel 110a and second channel 110b described previously, which are configured to receive the horizontal portion 104b of top connector 104. In embodiments, adaptor 810 may include channel sections that conform to the lower flange of I-beam 802 and provide clamping, bolting, or sliding engagement (e.g., as illustrated in FIG. 8D, the description of which applying herein). In embodiments, there may be one or more axial gaps between an end of I-beam 802 and an end of adaptor 810 (which may be similar to axial gaps discussed throughout this application—such as first gap 112a, second gap 112b, third gap 112c, and fourth gap 112d, the descriptions of which applying herein). In embodiments, such axial gaps may be configured to receive one or more lock blocks (such as lock block 410 described in connection with FIG. 5 and lock block 900, discussed in connection with FIGS. 9A and 9B, the descriptions of each applying herein).

In embodiments, adapter 810 may be affixed to the horizontal section 804b of top connector 804, while in other embodiments it may replace horizontal section 804b entirely. This configuration allows for stable load transfer and mechanical coupling between I-beam 802 and top connector 804, particularly in environments subject to vibration, torsion, or thermal cycling. In embodiments, adaptor may be composed of stainless steel, galvanized steel, extruded aluminum, or high-strength polymeric composites, depending on structural load requirements and environmental conditions.

Also depicted is cross-member 814, which is configured to interface with vertical column 806 at one end and with another, not-shown multi-configuration, modular apparatus at the other. The cross-member 814 includes apertures 814-1 and 814-2 located at each longitudinal end, configured to receive bolts or similar fasteners for structural coupling. Fastener 814-3, in some embodiments, is used to anchor cross-member 814 directly to the column-mounted coupling mechanism or another cross-support. One or more cross-members, in embodiments, may be included in multi-configuration, modular apparatus 800. These elements, in embodiments, enable modular lateral or diagonal bracing, helping to resist racking or vibration-based fatigue under industrial load conditions.

Top connector 804, in embodiments, comprises vertical section 804a and adapter 810. In embodiments, adapter 810 is sized and configured to receive I-beam 802 in a stable, load-bearing manner. In embodiments top connector 804 comprises vertical section 804a and horizontal section 804b. In embodiments, horizontal section 804b is sized and configured to receive I-beam 802 in a stable, load-bearing manner. In embodiments, I-beam 802 may be a standard structural I-beam used in commercial and industrial applications and may serve as a conduit carrier, framing member, structural interface, or a combination thereof, to name a few. I-beam 802 may be composed of galvanized steel, stainless steel, or other high-strength alloys suitable for heavy mechanical systems or utility racks.

Vertical column 806 is shown in an exploded position relative to baseplate 808. In embodiments, vertical column 806 may be received into vertical section 808a of baseplate 808. Vertical section 808a may comprise two regions of different diameter or width—808a-1 and 808a-2—configured to receive vertical column 806 in a pressure-fit arrangement, improving installation repeatability and eliminating the need for fine-tuned field fabrication. In embodiments, vertical section 808a may comprise one or more regions. Baseplate 808 also includes horizontal section 808b, which may serve as a platform for anchoring to a floor or other surface.

Fasteners 816a and 816b and corresponding washers/nuts 818a and 818b are shown positioned for securing baseplate 808 to a surface. These fasteners may be composed of stainless steel or treated steel, to name a couple, and, in some embodiments, may incorporate nylon washers or bushings to reduce galvanic corrosion, prevent seizing between dissimilar metals, and improve long-term durability in harsh environments.

Referring to FIG. 8B, illustrated is a side view of the assembled multi-configuration, modular apparatus 800. Assembled components include top connector 804, I-beam 802, vertical column 806, and baseplate 808. Adapter 810 is shown securing I-beam 802 to the top connector 804, either through a clamped fit, pressure engagement, or fastening arrangement. In this embodiment, adapter 810 replaces the previous multi-clip arrangement and offers a more integrated and robust interface for handling heavier loads or increasing installation repeatability. The remaining components—vertical column 806 and baseplate 808—are shown in assembled position, with fasteners visible securing the structure to a surface.

Fasteners 816b and 818b are shown securing baseplate 808 to the surface. The combination of vertical column 806 inserted into stepped vertical section 808a of baseplate 808 and anchored using fasteners enhances structural stability while maintaining modularity. In embodiments, many of these components, including, for example, cross-members, fasteners, and baseplates, may be shared with or analogous to the corresponding components in multi-configuration apparatus 100 described in previous figures, and those descriptions apply herein where relevant.

Referring now to FIG. 8C, illustrated is an isometric view of an adapter 820 for use with a multi-configuration, modular apparatus 800, in accordance with various embodiments of the present invention. In this embodiment, adapter 820 is configured to slide over horizontal section 804b of top connector 804, configured to create a supplemental interface to receive and secure I-beam 802. Adapter 820 may comprise first vertical section 820a, first horizontal section 820b, second vertical section 820c, second horizontal section 820d, and third horizontal section 820e. In embodiments, vertical sections 820a and 820c extend downward on opposing sides of horizontal section 804b, while horizontal sections 820b, 820d, and 820e form a U-or channel-like structure that engages with horizontal section 804b. Adapter 820, in embodiments, is configured to mimic the channeling function of extrusions 102d and 102e found in top support 102 of multi-configuration, modular apparatus 100.

In embodiments, adapter 820 may be fabricated from cast aluminum, extruded steel, reinforced polymer, other structural materials capable of withstanding industrial loads, or a combination thereof, to name a few. In embodiments, adapter 820 is designed for mounting a wider variety of I-beams or nonstandard beam geometries without requiring or only minimal modifications to top connector 804. This flexibility is particularly useful in field retrofits or installations subject to unique spatial or structural constraints. Adapter 820 may also distribute forces more uniformly across the I-beam-to-connector interface, enhancing durability and reducing localized wear. Adapter 820, in embodiments, may be similar to adapter 810, described above in connection with FIGS. 8A and 8B, the description of which applying herein.

In embodiments, adapter 820 reduces the number of needed clips by providing a more extensive mechanical interface. This can simplify installation and reduce the number of anchoring components, while still maintaining structural integrity. Adapter 820 may also be necessary to satisfy building codes or engineering specifications that govern beam anchorage, seismic resistance, or dynamic load criteria.

Referring now to FIG. 8D, illustrated is a portion 850 of a perspective view of multi-configuration, modular apparatus 800 in a fully assembled condition, incorporating adapter 820. Adapter 820 is shown receiving horizontal section 804b of top connector 804 and supporting I-beam 802. In this illustrated embodiment, top connector 804 is affixed to I-beam 802 via adaptor 820, illustrating a streamlined coupling configuration made possible through use of adapter 820.

The incorporation of adapter 820, in embodiments, offers both functional and regulatory advantages, making multi-configuration, modular apparatus 800 a more adaptable, robust, and installation-friendly option in industrial and commercial environments.

Referring now to FIGS. 9A and 9B, illustrated are side and isometric views, respectively, of lock-block 900, in accordance with various embodiments of the present invention.

In embodiments, lock block 900 is positioned between top connector 104 and top support 102 in first channel 110a and second channel 110b and may be similar to lock block 410, described previously in connection with FIGS. 1C and 5, all such descriptions applying herein. In embodiments, lock block 900 is configured to provide adjustability and alignment assistance during installation. For example, lock block 900 allows for fine-tuned horizontal positioning of top connector 104 within the extruded channels of top support 102, enabling crews to account for field conditions such as uneven terrain, sloped roofs, asymmetric conduit layouts, or minor measurement discrepancies.

In embodiments, lock block 900 is inserted into one or more of the axial gaps—such as first gap 112a, second gap 112b, third gap 112c, and fourth gap 112d. As another example, during installation, one or more lock blocks 900 may enable a field technician to slightly shift the pitch of top connector 104 within the extruded channels defined by top support 102 to achieve precise leveling, load alignment, or spacing relative to surrounding structures.

As illustrated in FIG. 9B, lock block 900 includes a protrusion 902, which is configured to assist in retaining the lock block 900 within a corresponding gap of a corresponding channel. In embodiments, protrusion 902 may create a snap-fit, interference fit, or detent engagement, to name a few, with the inner surface of the extrusion channel to help resist unintentional dislodgement during vibration, expansion/contraction cycles, or load transfer. While only one protrusion 902 is illustrated in FIG. 9B, in some embodiments, two or more protrusions may be positioned along one or more faces of lock block 900 to enhance grip, centering, or torsional resistance. In embodiments, lock block 900 may resist unintentional dislodgement via friction fit, detents, threaded inserts, or mechanical engagement features such as shoulders or notches, to name a few.

In some embodiments, lock block 900 may extend laterally from first channel 110a to second channel 110b, forming a spanning element configured to bridge the space between the two channels. In such configurations, lock block 900 may function as a continuous bar—formed from metal, polymer, or composite materials—positioned transversely across top connector 104 and seated within top support 102. This spanning configuration enables the lock block to simultaneously engage opposing sides of horizontal section 104b and apply symmetrical compression or resistance to lateral movement during or after installation. In embodiments, the cross-sectional dimensions of lock block 900 may be tailored for a friction or pressure fit, or may include one or more apertures to accommodate mechanical fastening. These apertures may be positioned on the top, bottom, or side faces of lock block 900 and aligned with corresponding apertures in top support 102 to allow securement via bolts, rivets, set screws, or pins. This configuration may be useful in field conditions requiring enhanced rigidity, redundant securing features, or compensation for off-center loading, vibration, or external force exposure. In embodiments, lock block 900 may be similar to lock block 410, described above in connection with FIG. 5, the description of which applying herein.

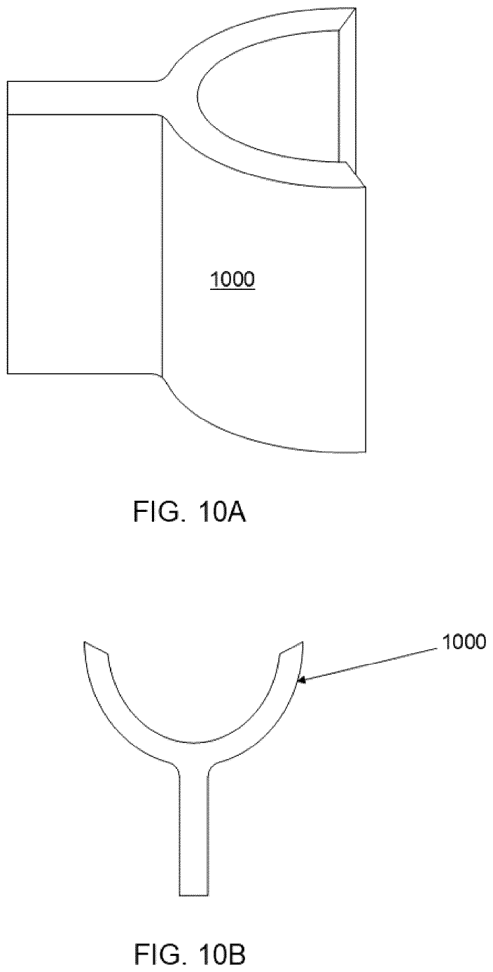

Referring now to FIGS. 10A and 10B, illustrated are perspective and top views, respectively, of structural support 1000 configured to be affixed to or integrated with a multi-configuration, modular apparatus (e.g., multi-configuration, modular apparatus 100, multi-configuration, modular apparatus 800), in accordance with various embodiments of the present invention. In some embodiments, structural support 1000 is similar in structure and function to support member 306 described above, and all relevant descriptions thereof apply herein.

Structural support 1000, in embodiments, is positioned adjacent to or in contact with a vertical column of a multi-configuration, modular apparatus (e.g., vertical column 106 or 806) and may extend outward at an angle to interface with a surface, wall, or other stable structure. In some embodiments, structural support 1000 is configured to resist lateral deflection or displacement of the modular apparatus caused by high winds, seismic activity, equipment vibration, or uneven load distribution. In embodiments, structural support 1000, is configured to assist transfer axial or torsional forces from the vertical column to the ground or adjacent infrastructure.

In embodiments, structural support 1000 is implemented with additional supports, such as a bolted beam, tubular brace, angled strut, or cable-tension system, and may be manufactured from galvanized steel, stainless steel, extruded aluminum, carbon-fiber composite, engineered polymers, or combination thereof, depending on load-bearing needs and environmental requirements. In embodiments, structural support 1000 may be removably affixed using flanges, threaded fasteners, brackets, or slip collars, allowing for modularity and ease of installation or removal.

In embodiments, structural support 1000 may be affixed to vertical column 106 or 806 via one or more fasteners. In embodiments, the one or more fasteners may be inserted through pre-formed apertures in structural support 1000. These apertures, in embodiments, may align with corresponding apertures on the vertical column to facilitate secure mechanical fastening. Suitable fasteners may include bolts, machine screws, rivets, or threaded inserts, depending on the structural requirements and desired permanence of installation. This configuration allows structural support 1000 to be securely integrated with the vertical column while still enabling disassembly or repositioning if necessary for field adjustment or maintenance.

Multiple structural supports 1000 may be employed in a single installation, and their placement can be tailored to site-specific constraints. For example, they may be positioned at 45°, 60°, or near-horizontal orientations, depending on the angle of force mitigation required. In some embodiments, structural support 1000 may also include adjustable feet or expansion anchors at the terminal end to provide a secure interface with irregular surfaces or to meet code-mandated uplift resistance thresholds.

By providing an auxiliary path for force redistribution and anchoring, in embodiments, structural support 1000 helps to enhance the safety, rigidity, and code compliance of the overall support system, particularly in high-risk installations or where free-standing supports may otherwise be vulnerable to tipping, swaying, or dynamic failure.

Referring now to FIG. 11, illustrated is an exemplary enlarged view 1100 of baseplate 808 assembly for multi-configuration, modular apparatus 800, in accordance with various embodiments of the present invention. This view 1100 highlights the interfacing geometry between vertical column 806 and baseplate 808, which comprises a vertical section 808a and horizontal section 808b. As shown, vertical section 808a includes top vertical section 808a-1 and bottom vertical section 808a-2, which together may define a stepped bore profile for receiving vertical column 806.

In embodiments, the inner diameter of top vertical section 808a-1 is slightly larger than the outer diameter of vertical column 806, allowing for a pressure-fit insertion that avoids the need for field welding or exact tolerance machining. Bottom vertical section 808a-2 may have a reduced diameter to act as a mechanical stop, limiting the insertion depth of vertical column 806. This arrangement, in embodiments, centers the column vertically and provides added lateral and torsional stability during operation.

This stepped bore profile is configured to enables safe, rapid, and repeatable installation while minimizing fabrication complexity. The difference in bore diameters may range, in some embodiments, from 1/16 inch to ¼ inch (1.5 mm to 6.5 mm), depending on column material and tolerances. In some embodiments, internal liners, gaskets, or shims may be employed to fine-tune the fit or mitigate galvanic reactions between dissimilar metals (e.g., aluminum column and steel baseplate).

In embodiments, baseplate 808 may be further affixed to vertical column 806 via one or more fasteners, e.g., threaded fasteners 1102a and 1102b. These fasteners may extend radially through the wall of vertical section 808a, passing into corresponding apertures in vertical column 806, thereby providing additional mechanical retention and reducing the risk of vertical slippage or rotational movement during use. In some embodiments, nylon washers or insulating bushings may be positioned between the fastener heads and the baseplate material to minimize galvanic corrosion or seizing between dissimilar metals. The fasteners themselves may include hex bolts, set screws, or locking pins, and may be selected based on the required shear load, environmental exposure, and field assembly preferences. This fastening configuration complements the pressure-fit arrangement and provides redundant securing to ensure compliance with stringent structural and safety codes across a variety of installation environments. In embodiments, fasteners 1102a and 1102b may serve as additional force to secure pressure fit between vertical column 806 and baseplate 808. In such embodiments, for example, vertical column 806 may not include mirroring apertures to receive fasteners 1102a and 1102b. In embodiments, one, two, or more fasteners may be used to affix baseplate 808 to vertical column 806.

Horizontal section 808b of baseplate 808 is depicted as a generally rectangular structure that distributes axial and lateral loads across the installation surface. In some embodiments, horizontal section 808b includes integrated apertures 1104a, 1104b, 1104c, and 1104d for anchoring to concrete pads, rooftop structures, or other surfaces using mechanical fasteners. This modular anchoring feature enables the system to meet a wide range of site-specific code and load requirements, including seismic, wind, and vibration standards.

The configuration shown in FIG. 11 may be incorporated into any of the previously described embodiments of a multi-configuration, modular apparatus (e.g., 100 or 800). The enlarged detail is for exemplary and explanatory purposes regarding the coupling of baseplate (108 and 808) to vertical column (106, 806).

FIG. 11 is an enlarged view of a baseplate, vertical column and fasteners of a multi-configuration, modular apparatus, in accordance with various embodiments of the present invention.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed:

1. A multi-configuration, modular stand comprising:
a first configuration comprising:
a baseplate configured to be coupled to a surface, the baseplate comprising:
a first horizontal section comprising a plurality of apertures operable to receive one or more bolts to mechanically couple the baseplate to the surface, wherein a first side of the first horizontal section is adjacent to the surface, and wherein the first horizontal section is substantially parallel to the surface; and
a first vertical section, wherein the first vertical section is a first tubular element, wherein the first vertical section is adjacent to a second side of the first horizontal section, wherein the first vertical section is coupled to the first horizontal section, and wherein the first vertical section has a first radius;
wherein the baseplate is made of extruded aluminum;
a vertical column, tubular in shape, the vertical column having a second radius sized to be received within the first vertical section, and wherein the vertical column is made of extruded aluminum; and
a top connector comprising:
a second horizontal section having a first thickness, the second horizontal section comprising a first side of the second horizontal section and a second side of the second horizontal section, wherein the second horizontal section is substantially parallel to the first horizontal section; and
a second vertical section, wherein the second vertical section is a second tubular element, wherein the second vertical section is adjacent to the first side of the second horizontal section, wherein the second vertical section has a third radius sized configured to receive to receive the vertical column, wherein the third radius is substantially similar to the first radius, and wherein the second vertical section is made of extruded aluminum; and
a top support comprising:
a third vertical section having a first end of the third vertical section and a second end of the third vertical section;
a third horizontal section having a first end of the third horizontal section and a second end of the second horizontal section; and
a fourth vertical section having a first end of the fourth vertical section and a second end of the fourth vertical section,
wherein the first end of the third vertical section is coupled to the first end of the third horizontal section and the second end of the second horizontal section is coupled to the first end of the fourth vertical section such that the third vertical section, third horizontal section, and fourth vertical section form a u-shape,
wherein the top support is made of extruded aluminum, and
wherein the top support comprises a plurality of channels, the plurality of channels comprising:
a first extruded channel having a first width configured to receive a first end of the second horizontal section having the first thickness, the first extruded channel being formed by a first portion of the third horizontal section, a first portion of the third vertical section, and a first channel section extending perpendicularly from the third vertical section and substantially parallel to the third horizontal section; and
a second extruded channel having a second width configured to receive a second end of the second horizontal section having the first thickness, wherein the second width is substantially similar to the first width, the second extruded channel being formed by a second portion of the third horizontal section, a first portion of the fourth vertical section, and a second channel section extending perpendicularly from the fourth vertical section and substantially parallel to the third horizontal section; and
a second configuration configured to support industrial piping, the second configuration comprising:
the first configuration assembled into a single stand, such that:
the first vertical section is coupled to a first end of the vertical column via pressure fitting the first end of the vertical column inside the first vertical section;
the second vertical section is coupled to a second end of the vertical column via pressure fitting the second end of the vertical column inside the second vertical section; and
the top support is coupled to the second horizontal section via pressure fitting a first end of the second horizontal section inside the first extruded channel and pressure fitting a second end of the second horizontal section inside the second extruded channel,
wherein the single stand is configured to support one-thousand pounds, and
wherein the single stand is configured to weigh less than one-hundred pounds.

2. The multi-configuration, modular stand of claim 1, wherein the first tubular element and the second tubular element are Schedule 40 or an equivalent structural pipe standard.

3. The multi-configuration, modular stand of claim 2, wherein the vertical column is Schedule 40 or an equivalent structural pipe standard.

4. The multi-configuration, modular stand of claim 1, wherein the first tubular element and the second tubular element are Schedule 80 or an equivalent structural pipe standard.

5. The multi-configuration, modular stand of claim 4, wherein the vertical column is Schedule 80 or an equivalent structural pipe standard.

6. The multi-configuration, modular stand of claim 1, wherein each of the one or more bolts comprises one or more washers made of nylon.

7. The multi-configuration, modular stand of claim 1, wherein:
when the first end of the second horizontal section is fully inserted in the first extruded channel, the first extruded channel comprises:
a first gap between a first proximal end of the second horizontal section and a second proximal end of the first extruded channel, wherein the first gap receives a first lock block configured to secure the first end of the second horizontal section; and
a second gap between a first distal end of the second horizontal section and a second distal point of the first extruded channel, wherein the second gap receives a second lock block configured to secure the first end of the second horizontal section; and
when the second end of the second horizontal section is fully inserted in the second extruded channel, the second extruded channel comprises:
a third gap between a third proximal end of the second horizontal section and a fourth proximal end of the second extruded channel, wherein the third gap receives a third lock block configured to secure the second end of the second horizontal section; and
a fourth gap between a third distal end of the second horizontal section a fourth distal end of the second extruded channel wherein the fourth gap receives a fourth lock block configured to secure the second end of the second horizontal section.

8. The multi-configuration, modular stand of claim 1, wherein:
a first intersection between the first portion of the first portion of the third horizontal section and the first portion of the third vertical section within the first extruded channel is formed at an angle greater than 90 degrees; and
a second intersection between the second portion of the first portion of the third horizontal section and the first portion of the fourth vertical section within the second extruded channel is formed at an angle greater than 90 degrees.

9. The multi-configuration, modular stand of claim 1, further comprising:
a second multi-configuration, modular stand configured to be connected to the multi-configuration, modular stand, the second multi-configuration, modular stand, comprising:
a second baseplate configured to be coupled to the surface, the baseplate comprising:
a fourth horizontal section, the fourth horizontal section being substantially parallel to the first horizontal section; and
a fifth vertical section, wherein the fifth vertical section is a third tubular element, wherein the fifth vertical section is adjacent to the fourth horizontal section, wherein the fifth vertical section is perpendicular to the fourth horizontal section, wherein the fifth vertical section is coupled to the fourth horizontal section, and wherein the fifth vertical section has a fourth radius;
wherein the second baseplate is made of extruded aluminum;
a second vertical column, tubular in shape, the second vertical column having a fifth radius sized to be received within the fifth vertical section, and wherein the second vertical column is made of extruded aluminum; and
a second top connector comprising:
a fifth horizontal section having a second thickness, the fifth horizontal section comprising a first side of the fifth horizontal section and a second side of the fifth horizontal section, wherein the fifth horizontal section is substantially parallel to the fourth horizontal section; and
a sixth vertical section, wherein the sixth vertical section is a fourth tubular element,
wherein the sixth vertical section is adjacent to the fifth horizontal section, wherein the sixth vertical section is perpendicular to the fifth horizontal section, wherein the second vertical section has a sixth radius sized configured to receive to receive the second vertical column, wherein the sixth radius is substantially similar to the fourth radius, and wherein the second vertical section is made of extruded aluminum; and
a second top support comprising:
a seventh vertical section having a first end of the seventh vertical section and a second end of the seventh vertical section;
a sixth horizontal section having a first end of the sixth horizontal section and a second end of the sixth horizontal section; and
an eighth vertical section having a first end of the eighth vertical section and a second end of the eighth vertical section,
wherein the first end of the seventh vertical section is coupled to the first end of the sixth horizontal section and the second end of the sixth horizontal section is coupled to the first end of the eighth vertical section such that the seventh vertical section, sixth horizontal section, and eighth vertical section form a second u-shape,
wherein the second top support is made of extruded aluminum, and
wherein the second top support comprises a second plurality of channels, the second plurality of channels comprising:
a third extruded channel having a third width configured to receive a first end of the fifth horizontal section having the second thickness; and
a fourth extruded channel having a fourth width configured to receive a second end of the fifth horizontal section having the second thickness, wherein the fourth width is substantially similar to the third width,
wherein the second multi-configuration, modular stand is assembled such that:
the fifth vertical section is coupled to a first end of the second vertical column via pressure fitting the first end of the second vertical column inside the fifth vertical section;
the sixth vertical section is coupled to a second end of the second vertical column via pressure fitting the second end of the second vertical column inside the sixth vertical section; and
the second top support is coupled to the second horizontal section via pressure fitting a first end of the fifth horizontal section inside the third extruded channel and pressure fitting a second end of the fifth horizontal section inside the fourth extruded channel.

10. The multi-configuration modular stand of claim 9, wherein:
the vertical column further comprises a first coupling element;
the second vertical further column comprises a second coupling element; and
the first coupling element is mechanically coupled to the second coupling element via a first cross-member support.

11. The multi-configuration, modular stand of claim 10, wherein the first coupling element and the second coupling element are on different planes.

12. The multi-configuration, modular stand of claim 10, wherein:
the vertical column further comprises a third coupling element;
the second vertical column further comprises a fourth coupling element; and
the third coupling element is mechanically coupled to the fourth coupling element via a second cross-member support.

13. The multi-configuration, modular stand of claim 12, wherein the third coupling element and the fourth coupling element are on different planes.

14. The multi-configuration, modular stand of claim 13, wherein the first coupling element and the third coupling element are substantially in a first plane, and wherein the second coupling element and the fourth coupling element are on a second plane.

15. The multi-configuration, modular stand of claim 9, wherein the multi-configuration modular stand is configured to support two-thousand pounds.

16. A multi-configuration, modular stand comprising:
a first configuration comprising:
a baseplate configured to be coupled to a surface, the baseplate comprising:
a first horizontal section comprising a plurality of apertures operable to receive one or more bolts to mechanically couple the baseplate to the surface, wherein a first side of the first horizontal section is adjacent to the surface, and wherein the first horizontal section is substantially parallel to the surface; and
a first vertical section, wherein the first vertical section is a first tubular element, wherein the first vertical section is adjacent to a second side of the first horizontal section, wherein the first vertical section is coupled to the first horizontal section, and wherein the first vertical section has a first radius;
wherein the baseplate is made of extruded aluminum;
a vertical column, tubular in shape, the vertical column having a second radius sized to be received within the first vertical section, and wherein the vertical column is made of extruded aluminum; and
a top connector comprising:
a second horizontal section, wherein the second horizontal section is substantially parallel to the first horizontal section, wherein the second horizontal section has a first width, and wherein the second horizontal section has a first length; and
a second vertical section, wherein the second vertical section is a second tubular element, wherein the second vertical section is adjacent to the first side of the second horizontal section, wherein the second vertical section having a third radius sized configured to receive to receive the vertical column, wherein the third radius is substantially similar to the first radius, and wherein the second vertical section is made of extruded aluminum; and
a top support comprising:
an I-beam having a second length and a second width, wherein the second length is greater than the first length, wherein the second width is configured to enable the I-beam to be mechanically coupled to the second horizontal section via a plurality of coupling mechanisms, wherein the plurality of coupling mechanisms comprise four collars configured to mechanically couple the I-beam and the second horizontal section; and
a second configuration configured to support industrial piping, the second configuration comprising:
the first configuration assembled into a single stand, such that:
the first vertical section is coupled to a first end of the vertical column via pressure fitting the first end of the vertical column inside the first vertical section;
the second vertical section is coupled to a second end of the vertical column via pressure fitting the second end of the vertical column inside the second vertical section; and
the I-beam is coupled to the second horizontal section via the plurality of coupling mechanisms,
wherein the single stand is configured to support two-thousand pounds.

17. The multi-configuration, modular stand of claim 16, further comprising:
a second multi-configuration, modular stand configured to be connected to the multi-configuration, modular stand, the second multi-configuration, modular stand, comprising:
a second baseplate configured to be coupled to the surface, the baseplate comprising:
a fourth horizontal section, the fourth horizontal section being substantially parallel to the first horizontal section; and
a fifth vertical section, wherein the fifth vertical section is a third tubular element, wherein the fifth vertical section is adjacent to the fourth horizontal section, wherein the fifth vertical section is perpendicular to the fourth horizontal section, wherein the fifth vertical section is coupled to the fourth horizontal section, and wherein the fifth vertical section has a fourth radius;
wherein the second baseplate is made of extruded aluminum;
a second vertical column, tubular in shape, the second vertical column having a fifth radius sized to be received within the fifth vertical section, and wherein the second vertical column is made of extruded aluminum; and
a second top connector comprising:
a fifth horizontal section having a second thickness, the fifth horizontal section comprising a first side of the fifth horizontal section and a second side of the fifth horizontal section, wherein the fifth horizontal section is substantially parallel to the fourth horizontal section; and
a sixth vertical section, wherein the sixth vertical section is a fourth tubular element,
wherein the sixth vertical section is adjacent to the fifth horizontal section, wherein the sixth vertical section is perpendicular to the fifth horizontal section, wherein the second vertical section has a sixth radius sized configured to receive to receive the second vertical column, wherein the sixth radius is substantially similar to the fourth radius, and wherein the second vertical section is made of extruded aluminum; and
a second top support comprising:
a second I-beam having a fourth length and a fourth width, wherein the fourth length is greater than the third length, wherein the fourth width is configured to enable the second I-beam to be mechanically coupled to the fourth horizontal section via a second plurality of coupling mechanisms, wherein the second plurality of coupling mechanisms comprise at least four collars configured to mechanically couple the second I-beam and the fourth horizontal section; and
wherein the second multiconfiguration, modular stand is assembled, such that:
the third vertical section is coupled to a first end of the second vertical column via pressure fitting the first end of the second vertical column inside the third vertical section;
the fourth vertical section is coupled to a second end of the second vertical column via pressure fitting the second end of the second vertical column inside the fourth vertical section; and
the second I-beam is coupled to the fourth horizontal section via the second plurality of coupling mechanisms.

18. The multi-configuration, modular stand of claim 17, wherein:
the vertical column further comprises a first coupling element;
the second vertical further column comprises a second coupling element; and
the first coupling element is mechanically coupled to the second coupling element via a first cross-member support.

19. The multi-configuration, modular stand of claim 18, wherein:
the vertical column further comprises a third coupling element;
the second vertical column further comprises a fourth coupling element; and
the third coupling element is mechanically coupled to the fourth coupling element via a second cross-member support.

20. The multi-configuration, modular stand of claim 14, wherein the first coupling element and the third coupling element are substantially in a first plane, wherein the second coupling element and the fourth coupling element are on a second plane, wherein the first plane is different from the second plane.
